(19) United States
(12) Patent Application Publication
(10) Pub. No.: US 2025/0033991 A1
(43) Pub. Date: Jan. 30, 2025

(54) ACTIVE ELECTRODE MATERIAL

(71) Applicant: Echion Technologies Limited, Cambridge (GB)

(72) Inventors: Alexander Groombridge, Cambridge (GB); Wanwei Zang, Cambridge (GB); Aasiya Hasan-Miyan, Cambridge (GB)

(73) Assignee: Echion Technologies Limited, Cambridge (GB)

(21) Appl. No.: 18/284,592

(22) PCT Filed: Mar. 31, 2022
(86) PCT No.: PCT/GB2022/050820

§ 371 Date: Sep. 28, 2023

(30) Foreign Application Priority Data
Apr. 1, 2021 (GB) 2104713.9

(51) Int. Cl. C01G 33/00; H01M 10/0525

(52) U.S. Cl. CPC C01G 33/006; H01M 10/0525; C01P 2002/72; C01P 2002/82; C01P 2004/51; C01P 2004/61; C01P 2004/62; C01P 2004/84; C01P 2006/12; C01P 2006/40

(57) ABSTRACT

The invention relates to active electrode materials and to methods for the manufacture of active electrode materials. Such materials are of interest as active electrode materials in lithium-ion or sodium-ion batteries. The invention provides an active electrode material comprising a mixed niobium oxide, wherein the mixed niobium oxide has the composition M1aM2i-aM3bNbi2-bO33-c-dQd, wherein: M1 and M2 are different; M1 is selected from Mg, Ca, Sr, Y, La, Ce, Ti, Zr, Hf, V, Nb, Ta, Cr, Mo, W, Mn, Fe, Co, Ni, Cu, Zn, Cd, B, Al, Ga, In, Si, Ge, Sn, Pb, P, Sb, Bi and mixtures thereof; M2 is Mo or W; M3 is selected from Mg, Ca, Sr, Y, La, Cc, Ti, Zr, Hf, V, Ta, Cr, Mo, W, Mn, Fe, Co, Ni, Cu, Zn, Cd, B, Al, Ga, In, Si, Ge, Sn, Pb, P, Sb, Bi, and mixtures thereof; Q is selected from F, Cl, Br, I, N, S, Se, and mixtures thereof; 0<a<0.5; 0<b<2; −0.5<c<1.65; 0<d<1.65; one or more of b and d is >0.

### FIELD OF THE INVENTION

The present invention relates to active electrode materials and to methods for the manufacture of active electrode materials. Such materials are of interest as active electrode materials in lithium-ion or sodium-ion batteries, for example as anode materials for lithium-ion batteries.

### BACKGROUND

Lithium-ion (Li-ion) batteries are a commonly used type of rechargeable battery with a global market predicted to grow to $200 bn by 2030. Li-ion batteries are the technology of choice for electric vehicles that have multiple demands across technical performance to environmental impact, providing a viable pathway for a green automotive industry.

A typical lithium-ion battery is composed of multiple cells connected in series or in parallel. Each individual cell is usually composed of an anode (negative polarity electrode) and a cathode (positive polarity electrode), separated by a porous, electrically insulating membrane (called a separator), immersed into a liquid (called an electrolyte) enabling lithium ions transport.

In most systems, the electrodes are composed of an electrochemically active material—meaning that it is able to chemically react with lithium ions to store and release them reversibly in a controlled manner—mixed if necessary with an electrically conductive additive (such as carbon) and a polymeric binder. A slurry of these components is coated as a thin film on a current collector (typically a thin foil of copper or aluminium), thus forming the electrode upon drying.

In the known Li-ion battery technology, the safety limitations of graphite anodes upon battery charging is a serious impediment to its application in high-power electronics, automotive and industry. Among a wide range of potential alternatives proposed recently, lithium titanate (LTO) and mixed niobium oxides are the main contenders to replace graphite as the active material of choice for high power, fast-charge applications.

Batteries relying on a graphitic anode are fundamentally limited in terms of charging rate. Under nominal conditions, lithium ions are inserted into the anode active material upon charging. When charging rate increases, typical graphite voltage profiles are such that there is a high risk that overpotentials lead to the potential of sites on the anode to become <0 V vs. Li/Li+, which leads to a phenomenon called lithium dendrite electroplating, whereby lithium ions instead deposit at the surface of the graphite electrode as lithium metal. This leads to irreversible loss of active lithium and hence rapid capacity fade of the cell. In some cases, these dendritic deposits can grow to such large sizes that they pierce the battery separator and lead to a short-circuit of the cell. This can trigger a catastrophic failure of the cell leading to a fire or an explosion. Accordingly, the fastest-charging batteries having graphitic anodes are limited to charging rates of 5-7 C, but often much less.

Lithium titanate (LTO) anodes do not suffer from dendrite electroplating at high charging rate thanks to their high potential (1.6 V vs. Li/Li+), and have excellent cycle life as they do not suffer from significant volume expansion of the active material upon intercalation of Li ions due to their accommodating 3D crystal structure. LTO cells are typically regarded as high safety cells for these two reasons. However, LTO is a relatively poor electronic and ionic conductor, which leads to limited capacity retention at high rate and resultant power performance, unless the material is nanosized to increase specific surface area, and carbon-coated to increase electronic conductivity. This particle-level material engineering increases the porosity and specific surface area of the active material, and results in a significantly lower achievable packing density in an electrode. This is significant because it leads to low density electrodes and a higher fraction of electrochemically inactive material (e.g. binder, carbon additive), resulting in much lower gravimetric and volumetric energy densities.

A key measure of anode performance is the electrode volumetric capacity (mAh/cm³), that is, the amount of electric charges (that is lithium ions) that can be stored per unit volume of the anode. This is an important factor to determine the overall battery energy density on a volumetric basis (Wh/L) when combined with the cathode and appropriate cell design parameters. Electrode volumetric capacity can be approximated as the product of electrode density (g/cm³), active material specific capacity (mAh/g), and fraction of active material in the electrode. LTO anodes typically have relatively low specific capacities (c. 165 mAh/g, to be compared with c. 330 mAh/g for graphite) which, combined with their low electrode densities (typically <2.0 g/cm³) and low active material fractions (<90%) discussed above, lead to very low volumetric capacities (<300 mAh/cm³) and therefore low battery energy density and high $/kWh cost in various applications. As a result, LTO batteries/cells are generally limited to specific niche applications, despite their long cycle life, fast-charging capability, and high safety.

Mixed niobium oxide structures have been of recent interest for use in Li-ion cells. WO2019234248A1, Saritha et al., Journal of Solid State Chemistry, Volume 183, Issue 5, May 2010, Pages 988-993, and Zhu et al., J. Mater. Chem. A, 2019, 7, 6522-6532 disclose WNb₁₂O₃₃ and MoNb₁₂O₃₃ as possible active electrode materials. However, it is believed that the properties of these materials can be improved. For example, these materials may not have sufficient electronic conductivity enough to allow for efficient charging and discharging in Li-ion cells for commercial use, resulting in excess impedance. In addition, improvements can still be made in Li ion capacity, coulombic efficiency, and in tuning the voltage profile of charge and discharge. Making these improvements as described herein without the need for extensive nanoscale or particle-level engineering, and without coatings, is an important step to low-cost battery materials for mass market uptakes. If these improvements are not addressed, then there is excess electrical resistance in a resultant device and lower energy densities, leading to increased polarisation, reduced power densities, lower energy efficiencies, and increased cost. Accordingly, there remains a need to improve the properties of WNb₁₂O₃₃ and MoNb₁₂O₃₃ for use in lithium-ion batteries.

### SUMMARY OF THE INVENTION

In a first aspect, the invention provides an active electrode material comprising a mixed niobium oxide, wherein the mixed niobium oxide has the composition M1ₐM2₁₋ₐM3_{b}Nb_{12-b}O_{33-c-d}Q_{d}, wherein:
M1 and M2 are different;
M1 is selected from Mg, Ca, Sr, Y, La, Ce, Ti, Zr, Hf, V, Nb, Ta, Cr, Mo, W, Mn, Fe, Co, Ni, Cu, Zn, Cd, B, Al, Ga, In, Si, Ge, Sn, Pb, P, Sb, Bi and mixtures thereof;
M2 is Mo or W;
M3 is selected from Mg, Ca, Sr, Y, La, Ce, Ti, Zr, Hf, V, Ta, Cr, Mo, W, Mn, Fe, Co, Ni, Cu, Zn, Cd, B, Al, Ga, In, Si, Ge, Sn, Pb, P, Sb, Bi, and mixtures thereof;
Q is selected from F, Cl, Br, I, N, S, Se, and mixtures thereof;
0≤a<0.5; 0≤b≤2; −0.5≤c≤1.65; 0≤d≤1.65;
one or more of b and d is >0.

It will be understood that the composition of the mixed niobium oxide does not correspond to stoichiometric WNb₁₂O₃₃ or MoNb₁₂O₃₃. The present inventors have found that by modifying WNb₁₂O₃₃ or MoNb₁₂O₃₃ by either incorporating further cations (M1 and/or M3), and/or by creating an induced oxygen deficiency or excess, and/or by forming mixed anion materials (comprising O and Q), the resulting material has improved electrochemical properties, and in particular improved electrochemical properties when used as an anode material. Since one or more of b and d is greater than zero, the mixed niobium oxide requires partial substitution of Nb for M3 and/or partial substitution of O for Q. When a>0, the mixed niobium oxide is further modified by partial substation of M2 (Mo or W) for M1. When c≠0, the mixed niobium oxide is further modified by oxygen deficiency or excess. The inventors have found that materials according to the invention have a significantly improved electronic conductivity, and improved coulombic efficiency, and improved delithiation specific capacity, compared to unmodified ‘base’ MoNb₁₂O₃₃, as shown by the present examples. This is an important result in demonstrating the advantages of the material of the invention for use in battery anodes.

The active electrode material of the invention is particularly useful in electrodes, preferably for use in anodes for lithium-ion or sodium-ion batteries. Therefore, in a further implementation of the invention the active electrode material of the first aspect comprises the mixed niobium oxide and at least one other component; optionally wherein the at least one other component is selected from a binder, a solvent, a conductive additive, a different active electrode material, and mixtures thereof. Such a composition is useful for fabricating an electrode. A further implementation of the invention is an electrode comprising the active electrode material of the first aspect in electrical contact with a current collector. A further implementation of the invention is an electrochemical device comprising an anode, a cathode, and an electrolyte disposed between the anode and the cathode, wherein the anode comprises an active electrode material according to the first aspect; optionally wherein the electrochemical device is a lithium-ion battery or a sodium-ion battery.

In a second aspect, the invention provides a method of making a mixed niobium oxide as defined by the first aspect, the method comprising steps of: providing one or more precursor materials; mixing said precursor materials to form a precursor material mixture; and heat treating the precursor material mixture in a temperature range from 400° C.-1350° C. or 800-1350° C., thereby providing the mixed niobium oxide. This represents a convenient and efficient method of making the active electrode material of the first aspect.

The invention includes the combination of the aspects and features described herein except where such a combination is clearly impermissible or expressly avoided.

### SUMMARY OF THE FIGURES

The principles of the invention will now be discussed with reference to the accompanying figures in which:

FIG. 1: Powder XRD of Samples 1, 2, 5, 10, 13, 14, and 17.

FIG. 2: Confocal Raman spectroscopy carried out Samples 2, 13, 15, 16, and 17. A laser excitation of 532 nm, attenuation of 10% and magnification of 50 was used on a Horiba Xplora Plus Raman microscope, with samples pressed into pellets at 10 MPa pressure, and placed on a glass slide. Spectra were recorded with on average an acquisition time of 15 s per scan, 3 repeats and 3 different sample locations in the spectral range of 0-2500 cm⁻¹.

FIG. 3 shows XRD diffraction patterns of samples R1, R4, R8, R2, R5, R9, R10, R11 and R12;

FIG. 4 shows XRD diffraction patterns of samples R6 and R7;

FIG. 5 shows representative lithiation and delithiation voltage profiles obtained by galvanostatic cycling in half cell configuration, 1.1-3.0 V voltage window, first 2 cycles at 0.05 C rate for samples R1 and R10;

FIG. 6 shows lithiation and delithiation capacity obtained by galvanostatic cycling in half cell configuration, 1.1-3.0 V voltage window, at current densities of 0.5 C, 1 C, 2 C, 5 C (seen as step-changes in the data) for samples R1, R4, and R10;

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

The term “mixed niobium oxide” (MNO) may refer to an oxide comprising niobium and at least one other cation. MNO materials have a high redox voltage vs. Lithium>0.8V, enabling safe and long lifetime operation, crucial for fast charging battery cells. Moreover, niobium cations can have two redox reactions per atom, resulting in higher theoretical capacities than, for example, LTO. The mixed niobium oxide described herein is derived from the base structure of WNb₁₂O₃₃ or MoNb₁₂O₃₃.

MoNb₁₂O₃₃ and WNb₁₂O₃₃ may be considered to have a ReO₃-derived MO₃₋ₓ crystal structure. Preferably, the mixed niobium oxide has a Wadsley-Roth crystal structure. Wadsley-Roth crystal structures are considered to be a crystallographic off-stoichiometry of the MO₃ (ReO₃) crystal structure containing crystallographic shear, with simplified formula of MO₃₋ₓ. As a result, these structures typically contain [MO₆] octahedral subunits in their crystal structure alongside others. The MNO materials with these structures are believed to have advantageous properties for use as active electrode materials, e.g. in lithium-ion batteries.

The open tunnel-like MO₃ crystal structure of MNO materials also makes them ideal candidates for having high capacity for Li ion storage and high rate intercalation/de-intercalation. The crystallographic off-stoichiometry present in the MNO structure causes the Wadsley-Roth crystallographic superstructure. These superstructures, compounded by other qualities such as the Jahn-Teller effect and enhanced crystallographic disorder by making use of multiple mixed cations, stabilise the crystal and keep the tunnels open and stable during intercalation, enabling extremely high rate performance due to high Li-ion diffusion rates (reported as 10⁻¹¹-10⁻¹² cm² s⁻¹).

The crystal formulae of MoNb₁₂O₃₃ or WNb₁₂O₃₃ can be described as having a 3×4×∞ crystallographic block structure, with corner-sharing tetrahedra ([WO₄] or [MoO₄]). The crystal formulae of WNb₁₂O₃₃ can be described as an isostructural phase to MoNb₁₂O₃₃ with slight differences in some bond lengths.

The total crystal composition of the materials described herein are preferably charge neutral and thermodynamically favourable to follow the above description. Structures deficient in their oxygen content through introduction of oxygen vacancy defects are preferable when reducing the material's electrical resistance such that MₓO_{y} becomes MₓO_{γ-δ}. Structures that have had cations (i.e. Mo, W, and Nb) or anions (i.e. O) substituted may have been so with matching valency (i.e. a 5+ cation for equal proportions of a 4+ and 6+ cation) or with unmatched valency, which can induce oxygen deficiency or excess if substitution takes place at equivalent crystal sites (e.g. Mo_{0.75}W_{0.25}Nb_{11.95}Zr_{0.05}O_{32.975} for deficiency, or Mo_{0.75}W_{0.25}Nb_{11.95}Mo_{0.05}O_{33.025} for excess). Substitution may also take place at different crystal sites, such as interstitial sites.

The crystal structure of a material may be determined by analysis of X-ray diffraction (XRD) patterns, as is widely known. For instance, XRD patterns obtained from a given material can be compared to known XRD patterns to confirm the crystal structure, e.g. via public databases such as the ICDD crystallography database. Rietveld analysis can also be used to determine the crystal structure of materials, in particular for the unit cell parameters. Therefore, the active electrode material may have a Wadsley-Roth crystal structure, as determined by X-ray diffraction.

Preferably, the crystal structure of the mixed niobium oxide, as determined by X-ray diffraction, corresponds to the crystal structure of WNb₁₂O₃₃ or MoNb₁₂O₃₃; most preferably MoNb₁₂O₃₃. In this way, it can be confirmed that the ‘base’ material has been modified without significantly affecting the crystal structure, which is believed to have advantageous properties for use as an active electrode material. The crystal structure of WNb₁₂O₃₃ may be found at ICDD crystallography database entry JCPDS 73-1322.

The mixed niobium oxide with cation/anion exchange may have unit cell parameters a, b, and c wherein a is 22.23-22.43 Å preferably 22.27-22.38 Å, b is 3.81-3.84 Å preferably 3.82-3.84 Å, and c=17.7-17.9 Å preferably 17.73-17.88 Å. The mixed niobium oxide may have unit cell parameters α and γ each being about 90°, preferably wherein α=γ=90°; whereas β is 123.1-123.7° preferably 123.2-123.65° and unit cell volume is 1260-1280 Å³ preferably 1264-1275 Å³. Unit cell parameters may be determined by X-ray diffraction. The mixed niobium oxide may have a crystallite size of 5-150 nm, preferably 30-60 nm, determined according to the Scherrer equation.

Here the term ‘corresponds’ is intended to reflect that peaks in an X-ray diffraction pattern may be shifted by no more than 0.5 degrees (preferably shifted by no more than 0.25 degrees, more preferably shifted by no more than 0.1 degrees) from corresponding peaks in an X-ray diffraction pattern of the material listed above.

The mixed niobium oxide has the composition M1ₐM2₁₋ₐM3_{b}Nb_{12-b}O_{33-c-d}Q_{d}, wherein:
M1 and M2 are different;
M1 is selected from Mg, Ca, Sr, Y, La, Ce, Ti, Zr, Hf, V, Nb, Ta, Cr, Mo, W, Mn, Fe, Co, Ni, Cu, Zn, Cd, B, Al, Ga, In, Si, Ge, Sn, Pb, P. Sb, Bi and mixtures thereof;
M2 is Mo or W;
M3 is selected from Mg, Ca, Sr, Y, La, Ce, Ti, Zr, Hf, V, Ta, Cr, Mo, W, Mn, Fe, Co, Ni, Cu, Zn, Cd, B, Al, Ga, In, Si, Ge, Sn, Pb, P. Sb, Bi, and mixtures thereof;
Q is selected from F, Cl, Br, I, N, S. Se, and mixtures thereof;
0≤a<0.5; 0≤5b≤2; −0.55≤c≤1.65; 0≤d≤1.65;
one or more of b and d is >0.

By ‘and mixtures thereof’, it is intended that M1, M2, M3, and Q may each represent two or more elements from their respective lists. An example of such a material is Ti_{0.05}W_{0.25}Mo_{0.70}Nb_{11.95}Al_{0.05}O_{32.9}. Here, M1 is Ti_{a′}W_{a″} (where a′+a″=a), M2 is Mo, M3 is Al, a=0.3, b=0.05, c=0.1, d=0. Here, c has been calculated assuming that each cation adopts its typical oxidation state, i.e. Ti⁴⁺, W⁶⁺, Mo⁶⁺, and Nb⁵⁺.

The precise values of a, b, c, d within the ranges defined may be selected to provide a charge balanced, or substantially charge balanced, crystal structure. Additionally or alternatively, the precise values of a, b, c, d within the ranges defined may be selected to provide a thermodynamically stable, or thermodynamically metastable, crystal structure.

When exchange of the cations or anions in the structure (i.e. Mo, W, Nb, O) have taken place without preserving the initial valency, this can give rise to both oxygen deficiency and excess. For example, a material that substitutes Nb⁵⁺ for Mo⁶⁺ to some extent will demonstrate minor oxygen excess (i.e. Nb₂O₅ vs MoO₃), whereas substitution of Nb⁵⁺ for Al³⁺ will show a minor oxygen deficiency (i.e. Nb₂O₅ vs Al₂O₃). Oxygen deficiency can also be induced through thermal treatment in inert or reducing conditions, which results in induced oxygen vacancy defects in the structure.

There may be partial oxidation or partial reduction to compensate for exchange which does not preserve the initial valency. For example, substitution of Nb⁵⁺ for Al³⁺ may be compensated at least in part by reduction of some Nb⁵⁺ to Nb⁴⁺.

M2 is Mo or W. Preferably, M2 is Mo in which case the material is based on MoNb₁₂O₃₃.

M1 is a cation which substitutes for M2 in the crystal structure. M1 may be selected from Mg, Ti, Zr, Hf, V, Nb, Ta, Cr, Mo, W, Mn, Fe, Co, Ni, Cu, Zn, Cd, B, Al, Ga, Si, Sn, P. and mixtures thereof; preferably Mg, Ti, Zr, V, Nb, Cr, Mo, W, Mn, Fe, Co, Ni, Cu, Zn, Cd, B, Al, Si, P, and mixtures thereof, most preferably Ti, Zr, V, Cr, Mo, W, Fe, Cu, Zn, Al, P, and mixtures thereof. M1 may have a different valency than M2⁶⁺. This gives rise to oxygen deficiency or excess. Preferably, M1 has a lower valency than M2⁶⁺. This gives rise to oxygen deficiency, i.e. the presence of oxygen vacancies providing the advantages discussed herein.

When more than one element is present as M1 or M3 it will be understood that the valency refers to M1 or M3 as a whole. For example, if 25 at % of M1 is Ti and 75 at % of M1 is W the valency M1 is 0.25×4 (the contribution from Ti)+0.75×6 (the contribution from W).

M1 preferably has a different ionic radius than M2⁶⁺, most preferably a larger ionic radius. This gives rise to changing unit cell size and local distortions in crystal structure, providing the advantages discussed herein. Ionic radii referred to herein are the Shannon ionic radii (available at R. D. Shannon, Acta Cryst., A32, 1976, 751-767) at the coordination and valency that the ion would be expected to adopt in the crystal structure of the mixed niobium oxide. For example, the crystal structure of MoNb₁₂O₃₃ includes Nb⁵⁺O₆ octahedra and Mo⁵⁺O₄ tetrahedra. Accordingly, when M3 is Zr the ionic radius is taken as that of 6-coordinate Zr⁴⁺ since this is typical valency and coordination of Zr when replacing Nb in MoNb₁₂O₃₃.

The amount of M1 is defined by a, meeting the criterion 0≤a<0.5. a may be 0≤a≤0.45, preferably 0≤a≤0.3. In each of these cases a may be >0. Higher values of a may be more readily achieved when M1 has the same valency as M2. When M1 comprises a cation with a 6+ valency (for example Mo or W) a may be 0≤a<0.5. When M1 does not comprise a cation with a 6+ valency a may be 0≤a≤0.2.

M3 is a cation which substitutes for Nb in the crystal structure. M3 may be selected from Mg, Ti, Zr, Hf, V, Ta, Cr, Mo, W, Mn, Fe, Co, Ni, Cu, Zn, Cd, B, Al, Ga, Si, Sn, P, and mixtures thereof, preferably Mg, Ti, Zr, V, Cr, Mo, W, Mn, Fe, Co, Ni, Cu, Zn, Cd, B, Al, Si, P, and mixtures thereof, most preferably Ti, Zr, V, Cr, Mo, W, Fe, Cu, Zn, Al, P, and mixtures thereof. M3 may have a different valency than Nb⁵⁺. This gives rise to oxygen deficiency or excess. Preferably, M3 has a lower valency than Nb⁵⁺. This gives rise to oxygen deficiency, i.e. the presence of oxygen vacancies providing the advantages discussed herein.

M3 preferably has a different ionic radius than Nb⁵⁺, most preferably a larger ionic radius. This gives rise to changing unit cell size and local distortions in crystal structure, providing the advantages discussed herein.

The amount of M3 is defined by b, meeting the criterion 0≤b≤2. b may be 0≤b≤1.0, preferably 0≤b≤0.2. In each of these cases b may be >0. Higher values of b may be more readily achieved when M3 has the same valency as Nb⁵⁺. When M3 comprises a cation with a 5+ valency (for example Ta) b may be 0≤b≤2. When M3 does not comprise a cation with a 5+ valency b may be 0≤b≤0.15.

Preferably, both a and b are >0. When both a and b are >0 the ‘base’ material has been substituted at both the M2 site (Mo or W) and at the Nb site. It has been found that such materials have further improved properties for use as active electrode materials.

c reflects the oxygen content of the mixed niobium oxide. When c is greater than 0, it forms an oxygen-deficient material, i.e. the material has oxygen vacancies. Such a material would not have precise charge balance without changes to cation oxygen state, but is considered to be “substantially charge balanced” as indicated above. Alternatively, c may equal 0, in which it is not an oxygen-deficient material. c may be below 0, which is a material with oxygen-excess. c may be −0.25≤c≤1.65. Preferably c is 0≤c≤1.65.

When c is 1.65, the number of oxygen vacancies is equivalent to 5% of the total oxygen in the crystal structure. c may be greater than 0.0165, greater than 0.033, greater than 0.066, or greater than 0.165. c may be between 0 and 1, between 0 and 0.75, between 0 and 0.5, or between 0 and 0.25. For example, c may satisfy 0.01≤c≤1.65. When the material is oxygen-deficient, the electrochemical properties of the material may be improved, for example, resistance measurements may show improved conductivity in comparison to equivalent non-oxygen-deficient materials. As will be understood, the percentage values expressed herein are in atomic percent.

The invention relates to mixed niobium oxides which may comprise oxygen vacancies (oxygen-deficient mixed niobium oxides), or which may have oxygen excess. Oxygen vacancies may be formed in a mixed niobium oxide by the sub-valent substitution of a base material as described above, and oxygen excess may be formed in a mixed niobium oxide by substitution for increased valency. Oxygen vacancies may also be formed by heating a mixed niobium oxide under reducing conditions, which may be termed forming induced oxygen deficiency. The amount of oxygen vacancies and excess may be expressed relative to the total amount of oxygen in the base material, i.e. the amount of oxygen in the un-substituted material (e.g. MoNb₁₂O₃₃).

A number of methods exist for determining whether oxygen vacancies are present in a material. For example, Thermogravimetric Analysis (TGA) may be performed to measure the mass change of a material when heated in air atmosphere. A material comprising oxygen vacancies can increase in mass when heated in air due to the material ‘re-oxidising’ and the oxygen vacancies being filled by oxide anions. The magnitude of the mass increase may be used to quantify the concentration of oxygen vacancies in the material, on the assumption that the mass increase occurs entirely due to the oxygen vacancies being filled. It should be noted that a material comprising oxygen vacancies may show an initial mass increase as the oxygen vacancies are filled, followed by a mass decrease at higher temperatures if the material undergoes thermal decomposition. Moreover, there may be overlapping mass loss and mass gain processes, meaning that some materials comprising oxygen vacancies may not show a mass gain (and sometimes not a mass loss or gain) during TGA analysis.

Other methods of determining whether oxygen vacancies are present include Raman spectroscopy, electron paramagnetic resonance (EPR), X-ray photoelectron spectroscopy (XPS, e.g. of oxygen 1s and/or and of cations in a mixed oxide), X-ray absorption near-edge structure (XANES, e.g. of cations in a mixed metal oxide), and TEM (e.g. scanning TEM (STEM) equipped with high-angle annular darkfield (HAADF) and annular bright-field (ABF) detectors). The presence of oxygen vacancies can be qualitatively determined by assessing the colour of a material relative to a non-oxygen-deficient sample of the same material, indicative of changes to its electronic band structure through interaction with light. For example, non-oxygen deficient stoichiometric MoNb₁₂O₃₃ has a white, off-white, or yellow colour. MoNb₁₂O_{<33} with induced oxygen deficiency has a purple colour. The presence of vacancies can also be inferred from the properties, e.g. electrical conductivity, of a stoichiometric material compared to those of an oxygen-deficient material.

When d>0, additional anions Q are introduced into the mixed niobium oxide. Due to their differing electronic structure (i.e. F⁻ vs O²⁻), and differing ionic radii (6-coordinate O²⁻=1.40 Å, 6-coordinate F⁻=1.33 Å) they may improve electrochemical performance in the active material. Error! Reference source not found. This is due to altering unit cell characteristics with differing ionic radii allowing for improved Li ion capacity, or improved Coulombic efficiencies by improving reversibility. They may additionally improve electrical conductivity as for oxygen vacancy defects, or sub-valent cation substitutions, by altering the electronic structure of the crystal (i.e. doping effects). d may be 0≤d≤1.0, or 0≤d≤0.8. In each of these cases d may be >0. Q may be selected from F, Cl, N, S, and mixtures thereof; or F, N, and mixtures thereof; or Q is N.

Optionally d=0, in which case the material has the composition M1ₐM2₁₋ₐM3_{b}Nb_{12-b}O_{33-c} where M1, M2, M3, a, b, and c are as defined herein. Advantageously, materials where d=0 are free from anion Q and may be easier to synthesise.

It will be understood that the discussion of the variables of the composition (M1, M2, M3, Q, a, b, c, and d) is intended to be read in combination. For example, preferably M1 is selected from Mg, Ti, Zr, V, Nb, Cr, Mo, W, Mn, Fe, Co, Ni, Cu, Zn, Cd, B, Al, Si, P, and mixtures thereof and M3 is selected from Mg, Ti, Zr, V, Cr, Mo, W, Mn, Fe, Co, Ni, Cu, Zn, Cd, B, Al, Si, P, and mixtures thereof and Q is selected from F, N, and mixtures thereof. Most preferably M1 and M3 are selected from Ti, Zr, V, Cr, Mo, W, Fe, Cu, Zn, Al, P, and mixtures thereof. Preferably 0≤a≤0.45 and 0≤b≤1.0 and 0≤d≤1.0.

For example, the mixed niobium oxide may have the composition M1ₐM2₁₋ₐM3_{b}Nb_{12-b}O_{33-c-d}Q_{d}, wherein:
M1 and M2 are different;
M1 is selected from Mg, Ti, Zr, V, Nb, Cr, Mo, W, Mn, Fe, Co, Ni, Cu, Zn, Cd, B, Al, Si, P, and mixtures thereof;
M2 is Mo or W;
M3 is selected from Mg, Ti, Zr, V, Cr, Mo, W, Mn, Fe, Co, Ni, Cu, Zn, Cd, B, Al, Si, P, and mixtures thereof;
Q is selected from F, N, and mixtures thereof;
0≤a≤0.45; 0≤b≤1.0; −0.5≤c≤1.65; 0≤d≤1.0;
one or more of b and d is >0.

For example, the mixed niobium oxide may have the composition M1ₐM2₁₋ₐM3_{b}Nb_{12-b}O_{33-c-d}Q_{d}, wherein:
M1 and M2 are different;
M1 is selected from Ti, Zr, V, Cr, Mo, W, Fe, Cu, Zn, Al, P, and mixtures thereof;
M2 is Mo or W;
M3 is selected from Ti, Zr, V, Cr, Mo, W, Fe, Cu, Zn, Al, P, and mixtures thereof;
Q is selected from F, N, and mixtures thereof;
0<a≤0.45; 0≤b≤0.2; −0.25≤c≤1.65; 0≤d≤0.8;
one or more of b and d is >0.

M1, M3, and Q may also be selected from each of the specific elements used as these dopants in the examples and reference examples.

The mixed niobium oxide may further comprise Li and/or Na. For example, Li and/or Na may enter the crystal structure when the mixed niobium oxide is used in a metal-ion battery electrode.

The mixed niobium oxide is preferably in particulate form. The material may have a D₅₀ particle diameter in the range of 0.1-100 μm, or 0.5-50 μm, or 1-20 μm. These particle sizes are advantageous because they are easy to process and fabricate into electrodes. Moreover, these particle sizes avoid the need to use complex and/or expensive methods for providing nanosized particles. Nanosized particles (e.g. particles having a D₅₀ particle diameter of 100 nm or less) are typically more complex to synthesise and require additional safety considerations.

The mixed niobium oxide may have a D₁₀ particle diameter of at least 0.05 μm, or at least 0.1 μm, or at least 0.5 μm, or at least 1 μm. By maintaining a D₁₀ particle diameter within these ranges, the potential for parasitic reactions in a Li ion cell is reduced from having reduced surface area, and it is easier to process with less binder in the electrode slurry.

The mixed niobium oxide may have a D₉₀ particle diameter of no more than 200 μm, no more than 100 μm, no more than 50 μm, or no more than 20 μm. By maintaining a D₉₀ particle diameter within these ranges, the proportion of the particle size distribution with large particle sizes is minimised, making the material easier to manufacture into a homogenous electrode.

The term “particle diameter” refers to the equivalent spherical diameter (esd), i.e. the diameter of a sphere having the same volume as a given particle, where the particle volume is understood to include the volume of any intra-particle pores. The terms “Dₙ” and “Dₙ particle diameter” refer to the diameter below which n % by volume of the particle population is found, i.e. the terms “D₅₀” and “D₅₀ particle diameter” refer to the volume-based median particle diameter below which 50% by volume of the particle population is found. Where a material comprises primary crystallites agglomerated into secondary particles, it will be understood that the particle diameter refers to the diameter of the secondary particles. Particle diameters can be determined by laser diffraction. Particle diameters can be determined in accordance with ISO 13320:2009, for example using Mie theory.

The mixed niobium oxide may have a BET surface area in the range of 0.1-100 m²/g, or 0.5-50 m²/g, or 1-20 m²/g. In general, a low BET surface area is preferred in order to minimise the reaction of the mixed niobium oxide with the electrolyte, e.g. minimising the formation of solid electrolyte interphase (SEI) layers during the first charge-discharge cycle of an electrode comprising the material. However, a BET surface area which is too low results in unacceptably low charging rate and capacity due to the inaccessibility of the bulk of the mixed niobium oxide to metal ions in the surrounding electrolyte.

The term “BET surface area” refers to the surface area per unit mass calculated from a measurement of the physical adsorption of gas molecules on a solid surface, using the Brunauer-Emmett-Teller theory. For example, BET surface areas can be determined in accordance with ISO 9277:2010.

The specific capacity/reversible delithiation capacity of the mixed niobium oxide may be 180 mAh/g or more, 190 mAh/g or more, up to about 200 mAh/g or more. Here, specific capacity is defined as that measured in the 2nd cycle of a half cell galvanostatic cycling test at a rate of 0.1 C with a voltage window of 1.1-3.0V vs Li/Li+ in a half cell. It may be advantageous to provide materials having a high specific capacity, as this can provide improved performance in an electrochemical device comprising the mixed niobium oxide.

When formulated or coated as an electrode according to the below description (optionally with conductive carbon additive and binder materials), the sheet resistance of the active electrode material may be 2.5 kΩ per square or less, more preferably 2.0 kΩ per square or less, which may be measured as defined in the examples. Sheet resistance can be a useful proxy measurement of the electronic conductivity of such materials. It may be advantageous to provide materials having a suitably low sheet resistance, as this can provide improved performance in an electrochemical device comprising the mixed niobium oxide.

The mixed niobium oxide may have a lithium diffusion rate greater than 10⁻¹⁴ cm² s⁻¹, or more preferably greater than 10⁻¹² cm² s⁻¹. It may be advantageous to provide materials having a suitably high lithium diffusion rate, as this can provide improved performance in an electrochemical device comprising the mixed niobium oxide.

The mixed niobium oxide may be able to form composite electrodes with a suitable binder and conductive additive according to the below description to provide an electrode density of 2.5 g/cm³ or more after calendaring. This enables a composite electrode with an electrode porosity (calculated by the measured electrode density/average of the true density of each component) in the range of 30-40%, in-line with industrial requirements for high energy and high power cells. For example, electrode densities of up to 3.2 g/cm³ have been achieved. It may be advantageous to provide materials having such an electrode density, as this can provide improved performance in an electrochemical device comprising the mixed niobium oxide. Specifically, when the electrode density is high, high volumetric capacities can be achieved, as gravimetric capacity×electrode density×mixed niobium oxide fraction=volumetric capacity.

Initial coulombic efficiency has been measured as the difference in the lithiation and de-lithiation capacity on the 1^{st} charge/discharge cycle at C/10 in a half-cell. The initial coulombic efficiency of the active electrode material may be greater than 87.5%, or greater than 88.0%, or greater than 88.2%. It may be advantageous to provide materials having a suitably high initial coulombic efficiency, as this can provide improved performance in an electrochemical device comprising the mixed niobium oxide.

The active electrode material of the first aspect of the invention may comprise the mixed niobium oxide and at least one other component, optionally wherein the at least one other component is selected from a binder, a solvent, a conductive additive, a different active electrode material, and mixtures thereof. Such a composition is useful for preparing an electrode, e.g. an anode for a lithium-ion battery. Preferably, the different active electrode material is selected from a different mixed niobium oxide having a composition as defined by the first aspect, a lithium titanium oxide, a niobium oxide, and mixtures thereof. Alternatively, the active electrode material may consist of the mixed niobium oxide.

The active electrode material may comprise the mixed niobium oxide and a lithium titanium oxide.

The lithium titanium oxide preferably has a spinal or ramsdellite crystal structure, e.g. as determined by X-ray diffraction. An example of a lithium titanium oxide having a spinal crystal structure is Li₄Ti₅O₁₂. An example of a lithium titanium oxide having a ramsdellite crystal structure is Li₂Ti₃O₇. These materials have been shown to have good properties for use as active electrode materials. Therefore, the lithium titanium oxide may have a crystal structure as determined by X-ray diffraction corresponding to Li₄Ti₅O₁₂ and/or Li₂Ti₃O₇. The lithium titanium oxide may be selected from Li₄Ti₅O₁₂, Li₂Ti₃O₇, and mixtures thereof.

The lithium titanium oxide may be doped with additional cations or anions. The lithium titanium oxide may be oxygen deficient. The lithium titanium oxide may comprise a coating, optionally wherein the coating is selected from carbon, polymers, metals, metal oxides, metalloids, phosphates, and fluorides.

The lithium titanium oxide may be synthesised by conventional ceramic techniques, for example solid-state synthesis or sol-gel synthesis. Alternatively, the lithium titanium oxide may be obtained from a commercial supplier.

The lithium titanium oxide is in preferably in particulate form. The lithium titanium oxide may have a D₅₀ particle diameter in the range of 0.1-50 μm, or 0.25-20 μm, or 0.5-15 μm. The lithium titanium oxide may have a D₁₀ particle diameter of at least 0.01 μm, or at least 0.1 μm, or at least 0.5 μm. The lithium titanium oxide may have a D₉₀ particle diameter of no more than 100 μm, no more than 50 μm, or no more than 25 μm. By maintaining a D₉₀ particle diameter in this range the packing of lithium titanium oxide particles in the mixture with mixed niobium oxide particles is improved.

Lithium titanium oxides are typically used in battery anodes at small particle sizes due to the low electronic conductivity of the material. In contrast, the mixed niobium oxide as defined herein may be used at larger particle sizes since it typically has a higher lithium ion diffusion coefficient than lithium titanium oxide. Advantageously, in the composition the lithium titanium oxide may have a smaller particle size than the mixed niobium oxide, for example such that the ratio of the D₅₀ particle diameter of the lithium titanium oxide to the D₅₀ particle diameter of the mixed niobium oxide is in the range of 0.01:1 to 0.9:1, or 0.1:1 to 0.7:1. In this way, the smaller lithium titanium oxide particles may be accommodated in the voids between the larger mixed niobium oxide particles, increasing the packing efficiency of the composition.

The lithium titanium oxide may have a BET surface area in the range of 0.1-100 m²/g, or 1-50 m²/g, or 3-30 m²/g.

The ratio by mass of the lithium titanium oxide to the mixed niobium oxide may be in the range of 0.5:99.5 to 99.5:0.5, preferably in the range of 2:98 to 98:2. In one implementation the active electrode material comprises a higher proportion of the lithium titanium oxide than the mixed niobium oxide, e.g. the ratio by mass of at least 2:1, at least 5:1, or at least 8:1. Advantageously, this allows the mixed niobium oxide to be incrementally introduced into existing electrodes based on lithium titanium oxides without requiring a large change in manufacturing techniques, providing an efficient way of improving the properties of existing electrodes. In another implementation the active electrode material has a higher proportion of the mixed niobium oxide than the lithium titanium oxide, e.g. such that the ratio by mass of the lithium titanium oxide to the mixed niobium oxide is less than 1:2, or less than 1:5, or less than 1:8. Advantageously, this allows for the cost of the active electrode material to be reduced by replacing some of the mixed niobium oxide with lithium titanium oxide.

The active electrode material may comprise the mixed niobium oxide and a niobium oxide.

The niobium oxide may be selected from Nb₁₂O₂₉, NbO₂, NbO, and Nb₂O₅. Preferably, the niobium oxide is Nb₂O₅.

The niobium oxide may be doped with additional cations or anions, for example provided that the crystal structure of the niobium oxide corresponds to the crystal structure of an oxide consisting of Nb and O, e.g. Nb₁₂O₂₉, NbO₂, NbO, and Nb₂O₅. The niobium oxide may be oxygen deficient. The niobium oxide may comprise a coating, optionally wherein the coating is selected from carbon, polymers, metals, metal oxides, metalloids, phosphates, and fluorides.

The niobium oxide may have the crystal structure of Nb₁₂O₂₉, NbO₂, NbO, or Nb₂O₅ as determined by X-ray diffraction. For example, the niobium oxide may have the crystal structure of orthorhombic Nb₂O₅ or the crystal structure of monoclinic Nb₂O₅. Preferably, the niobium oxide has the crystal structure of monoclinic Nb₂O₅, most preferably the crystal structure of H—Nb₂O₅. Further information on crystal structures of Nb₂O₅ may be found at Griffith et al., J. Am. Chem. Soc. 2016, 138, 28, 8888-8899.

The niobium oxide may be synthesised by conventional ceramic techniques, for example solid-state synthesis or sol-gel synthesis. Alternatively, the niobium oxide may be obtained from a commercial supplier.

The niobium oxide is in preferably in particulate form. The niobium oxide may have a D₅₀ particle diameter in the range of 0.1-100 μm, or 0.5-50 μm, or 1-20 μm. The niobium oxide may have a D₁₀ particle diameter of at least 0.05 μm, or at least 0.5 μm, or at least 1 μm. The niobium oxide may have a D₉₀ particle diameter of no more than 100 μm, no more than 50 μm, or no more than 25 μm. By maintaining a D₉₀ particle diameter in this range the packing of niobium oxide particles in the mixture with mixed niobium oxide particles is improved.

The niobium oxide may have a BET surface area in the range of 0.1-100 m²/g, or 1-50 m²/g, or 1-20 m²/g.

The ratio by mass of the niobium oxide to the mixed niobium oxide may be in the range of 0.5:99.5 to 99.5:0.5, or in the range of 2:98 to 98:2, or preferably in the range of 15:85 to 35:55.

The invention also provides an electrode comprising the active electrode material of the first aspect of the invention in electrical contact with a current collector. The electrode may form part of a cell. The electrode may form an anode as part of metal-ion battery, optionally a lithium-ion battery.

The invention also provides the use of the active electrode material of the first aspect of the invention in an anode for a metal-ion battery, optionally wherein the metal-ion battery is a lithium-ion battery.

A further implementation of the invention is an electrochemical device comprising an anode, a cathode, and an electrolyte disposed between the anode and the cathode, wherein the anode comprises an active electrode material according to the first aspect of the invention; optionally wherein the electrochemical device is metal-ion battery such as a lithium-ion battery or a sodium-ion battery. Preferably, the electrochemical device is a lithium-ion battery having a reversible anode active material specific capacity of greater than 200 mAh/g at 20 mA/g, wherein the battery can be charged and discharged at current densities relative to the anode active material of 200 mA/g or more, or 1000 mA/g or more, or 2000 mA/g or more, or 4000 mA/g or more whilst retaining greater than 70% of the initial cell capacity at 20 mA/g. It has been found that use of the active electrode materials of the first aspect of the invention can enable the production of a lithium-ion battery with this combination of properties, representing a lithium-ion battery that is particularly suitable for use in applications where high charge and discharge current densities are desired. Notably, the examples have shown that active electrode materials according to the first aspect of the invention have improved electronic conductivity and improved delithiation specific capacity.

The mixed niobium oxide may be synthesised by conventional ceramic techniques. For example, the material be made by one or more of solid-state synthesis or sol-gel synthesis. The material may additionally be synthesised by one or more of alternative techniques commonly used, such as hydrothermal or microwave hydrothermal synthesis, solvothermal or microwave solvothermal synthesis, coprecipitation synthesis, spark or microwave plasma synthesis, combustion synthesis, electrospinning, and mechanical alloying.

The second aspect of the invention provides a method of making a mixed niobium oxide as defined by the first aspect, the method comprising steps of: providing one or more precursor materials; mixing said precursor materials to form a precursor material mixture; and heat treating the precursor material mixture in a temperature range from 400° C.-1350° C. or 800-1350° C., thereby providing the mixed niobium oxide.

To provide a mixed niobium oxide comprising element Q the method may further comprise the steps of: mixing the mixed niobium oxide with a precursor comprising element Q to provide a further precursor material mixture; and heat treating the further precursor material mixture in a temperature range from 300-1200° C. or 800-1200° C. optionally under reducing conditions, thereby providing the mixed niobium oxide comprising element Q.

For example, to provide a mixed niobium oxide comprising N as element Q, the method may further comprise the steps of: mixing the mixed niobium oxide with a precursor comprising N (for example melamine) to provide a further precursor material mixture; and heat treating the further precursor material mixture in a temperature range from 300-1200° C. under reducing conditions (for example in N₂), thereby providing the mixed niobium oxide comprising N as element Q.

For example, to provide a mixed niobium oxide comprising F as element Q, the method may further comprise the steps of: mixing the mixed niobium oxide with a precursor comprising F (for example polyvinylidene fluoride) to provide a further precursor material mixture; and heat treating the further precursor material mixture in a temperature range from 300-1200° C. under oxidising conditions (for example in air), thereby providing the mixed niobium oxide comprising F as element Q.

The method may comprise the further step of heat treating the mixed niobium oxide or the mixed niobium oxide comprising element Q in a temperature range from 400-1350° C. or 800-1350° C. under reducing conditions, thereby inducing oxygen vacancies in the mixed niobium oxide. The induced oxygen vacancies may be in addition to oxygen vacancies already present in the mixed niobium oxide, e.g. already present due to sub-valent substitution of M2 and/or Nb with M1 and/or M3. Alternatively, the induced oxygen vacancies may be new oxygen vacancies, e.g. if M1 and M3 have the same valency as M2 and Nb. The presence of induced oxygen vacancies provides the advantages discussed herein.

The precursor materials may include one or more metal oxides, metal hydroxides, metal salts or ammonium salts. For example, the precursor materials may include one or more metal oxides or metal salts of different oxidation states and/or of different crystal structure. Examples of suitable precursor materials include but are not limited to: Nb₂O₅, Nb(OH)₅, Niobic Acid, NbO, Ammonium Niobate Oxalate, NH₄H₂PO₄, (NH₄)₂PO₄, (NH₄)₃PO₄, P₂O₅, H₃PO₃, Ta₂O₅, WO₃, ZrO₂, TiO₂, MoO₃, V₂O₅, ZrO₂, CuO, ZnO, Al₂O₃, K₂O, KOH, CaO, GeO₂, Ga₂O₃, SnO₂, CoO, Co₂O₃, Fe₂O₃, Fe₃O₄, MnO, MnO₂, NiO, Ni₂O₃, H₃BO₃, ZnO, and MgO. The precursor materials may not comprise a metal oxide, or may comprise ion sources other than oxides. For example, the precursor materials may comprise metal salts (e.g. NO₃⁻, SO₃⁻) or other compounds (e.g. oxalates, carbonates). For the substitution of the oxygen anion with other electronegative anions Q, the precursors comprising element Q may include one or more organic compounds, polymers, inorganic salts, organic salts, gases, or ammonium salts. Examples of suitable precursor materials comprising element Q include but are not limited to: melamine, NH₄HCO₃, NH₃, NH₄F, PVDF, PTFE, NH₄Cl, NH₄Br, NH₄I, Br₂, Cl₂, I₂, ammonium oxychloride amide, and hexamethylenetetramine.

Some or all of the precursor materials may be particulate materials. Where they are particulate materials, preferably they have a D₅₀ particle diameter of less than 20 μm in diameter, for example from 10 nm to 20 μm. Providing particulate materials with such a particle diameter can help to promote more intimate mixing of precursor materials, thereby resulting in more efficient solid-state reaction during the heat treatment step. However, it is not essential that the precursor materials have an initial particle size of <20 μm in diameter, as the particle size of the one or more precursor materials may be mechanically reduced during the step of mixing said precursor materials to form a precursor material mixture.

The step of mixing the precursor materials to form a precursor material mixture and/or further precursor material mixture may be performed by a process selected from (but not limited to): dry or wet planetary ball milling, rolling ball milling, high energy ball milling, high shear milling, air jet milling, steam jet milling, planetary mixing, and/or impact milling. The force used for mixing/milling may depend on the morphology of the precursor materials. For example, where some or all of the precursor materials have larger particle sizes (e.g. a D₅₀ particle diameter of greater than 20 μm), the milling force may be selected to reduce the particle diameter of the precursor materials such that the such that the particle diameter of the precursor material mixture is reduced to 20 μm in diameter or lower. When the particle diameter of particles in the precursor material mixture is 20 μm or less, this can promote a more efficient solid-state reaction of the precursor materials in the precursor material mixture during the heat treatment step. The solid state synthesis may also be undertaken in pellets formed at high pressure (>10 MPa) from the precursor powders.

The step of heat treating the precursor material mixture and/or the further precursor material mixture may be performed for a time of from 1 hour to 24 hours, more preferably from 3 hours to 18 hours. For example, the heat treatment step may be performed for 1 hour or more, 2 hours or more, 3 hours or more, 6 hours or more, or 12 hours or more. The heat treatment step may be performed for 24 hours or less, 18 hours or less, 16 hours or less, or 12 hours or less.

The step of heat treating the precursor material mixture may be performed in a gaseous atmosphere, preferably air. Suitable gaseous atmospheres include: air, N₂, Ar, He, CO₂, CO, O₂, Hz, NH₃ and mixtures thereof. The gaseous atmosphere may be a reducing atmosphere. Where it is desired to make an oxygen-deficient material, preferably the step of heat treating the precursor material mixture is performed in an inert or reducing atmosphere.

The step of heat treating the further precursor material mixture is performed under reducing conditions. Reducing conditions include under an inert gas such as nitrogen, helium, argon; or under a mixture of an inert gas and hydrogen; or under vacuum. Preferably, the step of heat treating the further precursor material mixture comprises heating under inert gas.

The further step of heat treating the mixed niobium oxide and/or the mixed niobium oxide comprising element Q under reducing conditions may be performed for a time of from 0.5 hour to 24 hours, more preferably from 2 hours to 18 hours. For example, the heat treatment step may be performed for 0.5 hour or more, 1 hours or more, 3 hours or more, 6 hours or more, or 12 hours or more. The further step heat treating may be performed for 24 hours or less, 18 hours or less, 16 hours or less, or 12 hours or less. Reducing conditions include under an inert gas such as nitrogen, helium, argon; or under a mixture of an inert gas and hydrogen; or under vacuum. Preferably heating under reducing conditions comprises heating under inert gas.

In some methods it may be beneficial to perform a two-step heat treatment. For example, the precursor material mixture and/or the further precursor material mixture may be heated at a first temperature for a first length of time, follow by heating at a second temperature for a second length of time. Preferably the second temperature is higher than the first temperature. Performing such a two-step heat treatment may assist the solid-state reaction to form the desired crystal structure. This may be carried out in sequence, or may be carried out with an intermediate re-grinding step.

The method may include one or more post-processing steps after formation of the mixed niobium oxide. In some cases, the method may include a post-processing step of heat treating the mixed niobium oxide, sometimes referred to as ‘annealing’. This post-processing heat treatment step may be performed in a different gaseous atmosphere to the step of heat treating the precursor material mixture to form the mixed niobium oxide. The post-processing heat treatment step may be performed in an inert or reducing gaseous atmosphere. Such a post-processing heat treatment step may be performed at temperatures of above 500° C., for example at about 900° C. Inclusion of a post-processing heat treatment step may be beneficial to e.g. form deficiencies or defects in the mixed niobium oxide, for example to induce oxygen deficiency; or to carry out anion exchange on the formed mixed niobium oxide e.g. N exchange for the O anion.

The method may include a step of milling and/or classifying the mixed niobium oxide (e.g. impact milling, jet milling, steam jet milling, high energy milling, high shear milling, pin milling, air classification, wheel classification, sieving) to provide a material with any of the particle size parameters given above.

There may be a step of carbon coating the mixed niobium oxide to improve its surface electrical conductivity, or to prevent reactions with electrolyte. This is typically comprised of combining the mixed niobium oxide with a carbon precursor to form an intermediate material that may comprise milling, preferably high energy milling. Alternatively or in addition, the step may comprise mixing the mixed niobium oxide with the carbon precursor in a solvent, such as water, ethanol or THF. These represent efficient methods of ensuring uniform mixing of the mixed niobium oxide with the carbon precursor.

It has been found that a carbon precursor comprising polyaromatic sp² carbon provides a particularly beneficial carbon coating on mixed niobium oxides of the first aspect of the invention. Therefore, the method of making a mixed niobium oxide may further comprise the steps of. combining the mixed niobium oxide or the mixed niobium oxide comprising element Q with a carbon precursor comprising polyaromatic sp² carbon to form an intermediate material; and heating the intermediate material under reducing conditions to pyrolyse the carbon precursor forming a carbon coating on the mixed niobium oxide and inducing oxygen vacancies in the mixed niobium oxide.

The intermediate material may comprise the carbon precursor in an amount of up to 25 wt %, or 0.1-15 wt %, or 0.2-8 wt %, based on the total weight of the mixed niobium oxide and the carbon precursor. The carbon coating on the mixed niobium oxide may be present in an amount of up to 10 wt %, or 0.05-5 wt %, or 0.1-3 wt %, based on the total weight of the mixed niobium oxide. These amounts of the carbon precursor and/or carbon coating provide a good balance between improving the electronic conductivity by the carbon coating without overly reducing the capacity of the mixed niobium oxide by overly reducing the proportion of the mixed niobium oxide. The mass of carbon precursor lost during pyrolysis may be in the range of 30-70 wt %.

The step of heating the intermediate material under reducing conditions may be performed at a temperature in the range of 400-1,200° C., or 500-1,100° C., or 600-900° C. The step of heating the intermediate material under reducing conditions may be performed for a duration within the range of 30 minutes to 12 hours, 1-9 hours, or 2-6 hours.

The step of heating the intermediate material under reducing conditions may be performed under an inert gas such as nitrogen, helium, argon; or may be performed under a mixture of an inert gas and hydrogen; or may be performed under vacuum.

The carbon precursor comprising polyaromatic sp² carbon may be selected from pitch carbons, graphene oxide, graphene, and mixtures thereof. Preferably, the carbon precursor comprising polyaromatic sp² carbon is selected from pitch carbons, graphene oxide, and mixtures thereof. Most preferably, the carbon precursor comprising polyaromatic sp² carbon is selected from pitch carbons. The pitch carbons may be selected from coal tar pitch, petroleum pitch, mesophase pitch, wood tar pitch, isotropic pitch, bitumen, and mixtures thereof.

Pitch carbon is a mixture of aromatic hydrocarbons of different molecular weights. Pitch carbon is a low cost by-product from petroleum refineries and is widely available. The use of pitch carbon is advantageous because pitch has a low content of oxygen. Therefore, in combination with heating the intermediate material under reducing conditions, the use of pitch favours the formation of oxygen vacancies in the mixed niobium oxide.

Other carbon precursors typically contain substantial amounts of oxygen. For example, carbohydrates such as glucose and sucrose are often used as carbon precursors. These have the empirical formula Cₘ(H₂O)ₙ and thus contain a significant amount of covalently-bonded oxygen (e.g. sucrose has the formula C₁₂H₂₂O₁₁ and is about 42 wt % oxygen). The pyrolysis of carbon precursors which contain substantial amounts of oxygen is believed to prevent or inhibit reduction of a mixed niobium oxide, or even lead to oxidation, meaning that oxygen vacancies may not be induced in the mixed niobium oxide. Accordingly, the carbon precursor may have an oxygen content of less than 10 wt %, preferably less than 5 wt %.

The carbon precursor may be substantially free of sp³ carbon. For example, the carbon precursor may comprise less than 10 wt % sources of sp³ carbon, preferably less than 5 wt % sources of sp³ carbon. Carbohydrates are sources of sp³ carbon. The carbon precursor may be free of carbohydrates. It will be understood that some carbon precursors used in the invention may contain impurities of sp³ carbon, for example up to 3 wt %.

The mixed niobium oxide of the first aspect of the invention may comprise a carbon coating. Preferably the carbon coating comprises polyaromatic sp² carbon. Such a coating is formed by pyrolysing a carbon precursor comprising polyaromatic sp² carbon, preferably under reducing conditions, since the sp² hybridisation is largely retained during pyrolysis. Typically, pyrolysis of a polyaromatic sp² carbon precursor under reducing conditions results in the domains of sp² aromatic carbon increasing in size. Accordingly, the presence of a carbon coating comprising polyaromatic sp² may be established via knowledge of the precursor used to make the coating. The carbon coating may be defined as a carbon coating formed from pyrolysis of a carbon precursor comprising polyaromatic sp² carbon. Preferably, the carbon coating is derived from pitch carbons.

The presence of a carbon coating comprising polyaromatic sp² carbon may also be established by routine spectroscopic techniques. For instance, Raman spectroscopy provides characteristic peaks (most observed in the region 1,000-3,500 cm⁻¹) which can be used to identify the presence of different forms of carbon. A highly crystalline sample of sp³ carbon (e.g. diamond) provides a narrow characteristic peak at ˜1332 cm⁻¹. Polyaromatic sp² carbon typically provides characteristic D, G, and 2D peaks. The relative intensity of D and G peaks (I_{D}/I_{G}) can provide information on the relative proportion of sp² to sp³ carbon. The mixed niobium oxide may have an I_{D}/I_{G} ratio as observed by Raman spectroscopy within the range of 0.85-1.15, or 0.90-1.10, or 0.95-1.05.

X-ray diffraction may also be used to provide information on the type of carbon coating. For example, an XRD pattern of a mixed niobium oxide with a carbon coating may be compared to an XRD pattern of the uncoated mixed niobium oxide and/or to an XRD pattern of a pyrolysed sample of the carbon precursor used to make the carbon coating.

The carbon coating may be semi-crystalline. For example, the carbon coating may provide a peak in an XRD pattern of the mixed niobium oxide centred at 2θ of about 26° with a width (full width at half maximum) of at least 0.20°, or at least 0.25°, or at least 0.30°.

### EXAMPLES

The mixed niobium oxides were synthesised by a solid-state route. In a first step precursor materials (Nb₂O₅, NH₄H₂PO₄, MoO₃, Al₂O₃, WO₃, ZrO₂, ZnO) were mixed in stoichiometric proportions (50 g total) and ball-milled at 350 rpm with a ball to powder ratio of 10:1 for 1 h. The resulting powders were heat treated in an alumina crucible in a muffle furnace in air at T₁ₐ=250-800° C. for 1-12 h followed by T_{1b}=800-1350° C. for 2-16 h, providing the desired Wadsley-Roth phase. An additional heat treatment step was also applied in some cases under a N₂ atmosphere at T₂=800-1350° C. for 1-12 h. For inclusion of anions, there was an additional milling/mixing step with the precursor (C₃H₆N₆ in a 1:3 mass ratio versus the parent material for N, PVDF in a 1:10 mass ratio for F) prior to heat treatment in a N₂ or air atmosphere at T₂=300-1200° C. for 1-12 h.

A final de-agglomeration step was utilised by impact milling or jet milling to adjust to the desired particle size distribution where necessary. Specifically, the material was de-agglomerated by impact milling at 20,000 RPM for 10 seconds.

TABLE 1
A summary of the materials synthesised. Particle size distribution
has been evaluated by dry powder laser diffraction.

| | | T₁ₐ | T_{1b} | T₂ | D10 | D50 | D90 |
|---|---|---|---|---|---|---|---|
| Sample | Material | (° C.; h) | (° C.; h) | (° C.; h) | (μm) | (μm) | (μm) |
| 1* | MoNb₁₂O₃₃ | — | 900; 12 | — | 1.3 | 4.8 | 11.0 |
| 2** | Mo_{0.75}W_{0.25}Nb₁₂O₃₃ | — | 900; 12 | — | 1.5 | 4.7 | 9.7 |
| 3 | Mo_{0.75}W_{0.25}Nb_{11.95}Zr_{0.05}O_{32.975} | — | 900; 12 | — | 1.7 | 5.4 | 11.6 |
| 4 | Mo_{0.75}W_{0.25}Nb_{11.9}Zr_{0.1}O_{32.95} | — | 900; 12 | — | 2.4 | 5.3 | 9.9 |
| 5 | Mo_{0.75}W_{0.25}Nb_{11.95}Al_{0.05}O_{32.95} | — | 900; 12 | — | 1.3 | 4.7 | 10.3 |
| 6 | Mo_{0.75}W_{0.25}Nb_{11.95}Zn_{0.05}O_{32.925} | — | 900; 12 | — | — | — | — |
| 7 | Mo_{0.75}W_{0.25}Nb_{11.95}Mo_{0.05}O_{33.025} | — | 900; 12 | — | 2.3 | 5.6 | 10.9 |
| 8 | Mo_{0.75}W_{0.25}Nb_{11.95}W_{0.05}O_{33.025} | — | 900; 12 | — | — | — | — |
| 9 | Mo_{0.75}W_{0.25}Nb_{11.95}P_{0.05}O₃₃ | 380; 3 | 900; 12 | — | 2.4 | 5.4 | 10.1 |
| 10 | Mo_{0.75}W_{0.25}Nb₁₂O_{33-y}N_{y} | — | 900; 12 | 700; 10^{†} | 2.1 | 5.9 | 12.2 |
| 12 | Mo_{0.75}W_{0.25}Nb_{11.9}Zr_{0.1}O_{32.95-y}F_{y} | 900; 12 | 950; 5^{†} | 375; 24 | 0.8 | 5.5 | 16.7 |
| 13 | Mo_{0.75}W_{0.25}Nb_{11.95}Al_{0.05}O_{32.95-y}F_{y} | 900; 12 | 950; 5^{†} | 375; 24 | — | — | — |
| 14*** | Mo_{0.75}W_{0.25}Nb_{11.95}Al_{0.05}O_{32.95-y} | 900; 12 | 950; 5^{†} | — | 0.9 | 4.7 | 13.8 |
| 15*** | Mo_{0.75}W_{0.25}Nb_{11.95}Mo_{0.05}O_{33.025-y} | 900; 12 | 950; 5^{†} | — | 0.8 | 3.6 | 9.8 |
| 16*** | Mo_{0.75}W_{0.25}Nb_{11.9}Zr_{0.1}O_{32.95-y-z}N_{z} | 900; 12 | 700; 10^{†} | 950; 5^{†} | — | — | — |
| 17*** | Mo_{0.75}W_{0.25}Nb₁₂O_{33-y-z}N_{z} | 900; 12 | 700; 10^{†} | 950; 5^{†} | — | — | — |

*Comparative sample - unmodified ‘base’ MoNb₁₂O₃₃
**Comparative sample - MoNb₁₂O₃₃ with cation exchange at M2 site
***Induced oxygen deficiency may be calculated from e.g. TGA
^{†}This heat treatment step was carried out in a N₂ atmosphere. All others were carried out in an air atmosphere.

### Materials Characterisation

The phase purity of samples was analysed using a Rigaku Miniflex powder X-ray diffractometer in 20 range (10-70°) at 1°/min scan rate.

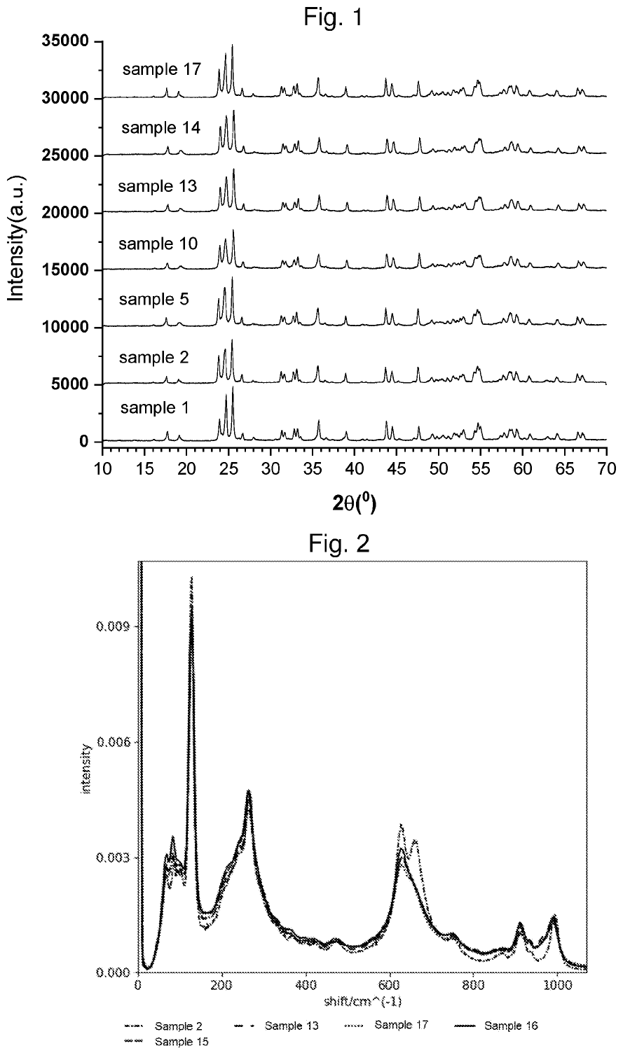

FIG. 1 shows the measured XRD diffraction patterns for Samples 1, 2, 5, 10, 13, 14, 17. Diffraction patterns have peaks at the same locations (with some shift due to crystal modification, up to around 0.2°), and match ICDD crystallography database entry JCPDS, which corresponds to JCPDS 73-1322. There is no amorphous background noise and the peaks are sharp and intense. This means that all samples are crystalline, with crystallite size 35-42 nm according to the Scherrer equation and crystal structure matching MoNb₁₂O₃₃ or the isostructural WNb₁₂O₃₃. This confirms the presence of a Wadsley-Roth crystal structure.

TABLE 2
A summary table of unit cell parameters for selected samples calculated
by Rietveld refinement of their powder XRD spectra with software
GSASII, and average crystallite size calculated by the Scherrer equation
across the spectra. χ² represents the goodness of fit and
is a representation of how accurate the Rietveld refinement is,
a value ≤10 supports the accuracy of the data.

| | | | | | | | Crystallite |
|---|---|---|---|---|---|---|---|
| Sample | a [Å] | b [Å] | c [Å] | β [°] | Vol(Å³) | χ² | size [nm] |
| Reference | 22.370 | 3.825 | 17.870 | 123.60 | 1273.58 | — | — |
| 1* | 22.285 | 3.826 | 17.744 | 123.3 | 1264.81 | 9 | 37.9 |
| 2** | 22.327 | 3.833 | 17.794 | 123.28 | 1273.27 | 10 | 38.3 |
| 4 | 22.314 | 3.833 | 17.781 | 123.28 | 1271.72 | 8 | 41.4 |
| 5 | 22.312 | 3.836 | 17.786 | 123.29 | 1271.26 | 9 | 40.2 |
| 10 | 22.322 | 3.834 | 17.806 | 123.22 | 1275.07 | 10 | 35.5 |
| 13 | 22.315 | 3.829 | 17.799 | 123.31 | 1271.20 | 9 | 36.2 |
| 14 | 22.316 | 3.832 | 17.797 | 123.23 | 1273.16 | 10 | 36.0 |

Particle Size Distributions were obtained with a Horiba laser diffraction particle analyser for dry powder. Air pressure was kept at 0.3 MPa. The results are set out in Table 1.

Confocal Raman spectroscopy was carried out on selected samples. A laser excitation of 532 nm, attenuation of 10% and magnification of 50 was used on a Horiba Xplora Plus Raman microscope, with samples pressed into pellets at 10 MPa pressure, and placed on a glass slide. Spectra were recorded with on average an acquisition time of 15 s per scan, 3 repeats and 3 different sample locations in the spectral range of 0-2500 cm⁻¹. Peaks characteristic to structures containing Nb, O, species can be found in the region 500-700 cm⁻¹, those relating to longer Nb—O bonds in corner-shared octahedral units at 760-770 cm⁻¹, distorted octahedral species relating to O═Nb—O at 890-900 cm⁻¹, and shorter Nb—O bonds as in edge shared octahedra at 1000 cm⁻¹. Notably, Sample 2** contains a peak at ˜650 cm⁻¹ which is absent in Samples 13, 15, 16, and 17. This is believed to provide proof of change to Nb—O bonds in the material which is evidence of the modification to the crystal structure caused by the induced oxygen vacancies and/or substitution of O by N or F.

Inductively coupled plasma (ICP) atomic emission spectroscopy was carried out on Sample 12 to determine the fluorine content. The chemical composition of this sample was found to be Mo_{0.75}W_{0.25}Nb_{11.9}Zr_{0.1}O_{32.94}F_{0.01} (i.e. y=0.01).

### Electrochemical Characterisation

Li-ion cell charge rate is usually expressed as a “C-rate”. A 1 C charge rate means a charge current such that the cell is fully charged in 1 h, 10 C charge means that the battery is fully charged in 1/10th of an hour (6 minutes). C-rate hereon is defined from the reversible capacity observed of the anode within the voltage limits applied in its second cycle de-lithiation, i.e. for an anode that exhibits 1.0 mAh cm⁻² capacity within the voltage limits of 1.1-3.0 V, a 1 C rate corresponds to a current density applied of 1.0 mA cm⁻². In a typical MNO material as described herein, this corresponds to ˜200 mA/g of active material.

Electrochemical tests were carried out in half-coin cells (CR2032 size) for analysis. In half-coin tests, the active material is tested in an electrode versus a Li metal electrode to assess its fundamental performance. In the below examples, the active material composition to be tested was combined with N-Methyl Pyrrolidone (NMP), carbon black (Super P) acting as a conductive additive, and poly(vinyldifluoride) (PVDF) binder and mixed to form a slurry using a lab-scale centrifugal planetary mixer. The non-NMP composition of the slurries was 92 wt % active material, 3 wt % conductive additive, 5 wt % binder. The slurry was coated on an Al foil current collector to the desired loading of 69-75 g m⁻² by doctor blade coating and dried by heating. The electrodes were then calendared to a density of 2.6-3.2 g cm⁻³ at 80° C. to achieve targeted porosities of 35-40%. Electrodes were punched out at the desired size and combined with a separator (Celgard porous PP/PE), Li metal, and electrolyte (1.3 M LiPF₆ in EC/DEC) inside a steel coin cell casing and sealed under pressure. Cycling was then carried out at 23° C. at low current rates (C/10) for 2 full cycles of lithiation and de-lithiation between 1.1-3.0 V. Data has been averaged from 5 cells prepared from the same electrode coating, with the error shown from the standard deviation. Accordingly, the data represent a robust study showing the improvements achieved by the materials according to the invention compared to prior materials.

The electrical resistivity of the electrode coating was separately assessed by a 4-point-probe method with an Ossila instrument. An electrode coating was prepared to a mass loading of 69-75 g cm⁻² and calendared to a porosity of 35-40% on a sheet of insulating mylar for all samples. The sheet resistance was then measured on a 14 mm diameter disc in units of Ω per square at constant temperature of 23° C.

Homogeneous, smooth coatings on both Cu and Al current collector foils, the coatings being free of visible defects or aggregates may also be prepared as above for these samples with a centrifugal planetary mixer to a composition of up to 94 wt % active material, 4 wt % conductive additive, 2 wt % binder. These can be prepared with both PVDF (i.e. NMP-based) and CMC:SBR-based (i.e. water-based) binder systems. The coatings can be calendared at 80° C. for PVDF and 50° C. for CMC:SBR to porosities of 35-40% at loadings from 1.0 to 5.0 mAh cm⁻². This is important to demonstrate the viability of these materials in both high energy and high-power applications, with high active material content.

TABLE 3
A summary of electrical resistance measurements carried
out as described. Resistivity was measured by 4-point-
probe techniques, on equivalent coatings on mylar.

| Sample | Sheet resistance [kΩ per square] |
|---|---|
| 1* | 2.96 ± 0.31 |
| 2** | 1.26 ± 0.04 |
| 3 | 1.58 ± 0.13 |
| 4 | 2.60 ± 0.11 |
| 5 | 1.43 ± 0.09 |
| 7 | 2.11 ± 0.26 |
| 9 | 1.77 ± 0.07 |
| 10 | 1.29 ± 0.11 |
| 12 | 1.20 ± 0.14 |
| 14 | 1.41 ± 0.04 |

TABLE 4
A summary of electrochemical testing results from Li-
ion half coin cells. In general it is beneficial to have
a higher capacity, and a higher Coulombic efficiency.

| | Delithiation | Coulombic | Coulombic |
|---|---|---|---|
| | specific | efficiency | efficiency |
| | capacity 2^{nd} C/10 | 1^{st} cycle | 2^{nd} cycle |
| Sample | cycle [mAh/g] | at C/10 [%] | at C/10 [%] |
| 1* | 200.5 ± 2.8 | 87.7 ± 0.7 | 98.8 ± 0.1 |
| 2** | 199.4 ± 3.2 | 88.8 ± 0.2 | 99.4 ± 0.1 |
| 3 | 203.0 ± 3.5 | 88.1 ± 0.0 | 99.3 ± 0.0 |
| 4 | 202.3 ± 4.5 | 85.5 ± 0.1 | 99.4 ± 1.1 |
| 5 | 201.2 ± 2.6 | 88.4 ± 0.1 | 99.7 ± 0.0 |
| 7 | 203.6 ± 11.2 | 91.2 ± 0.0 | 99.2 ± 0.0 |
| 9 | 208.1 ± 0.8 | 90.1 ± 0.0 | 99.3 ± 0.0 |
| 10 | 203.6 ± 7.0 | 88.3 ± 0.6 | 98.8 ± 0.2 |
| 12 | 205.1 ± 7.5 | 90.4 ± 0.2 | 99.3 ± 0.2 |
| 14 | 206.9 ± 10.1 | 90.6 ± 1.0 | 99.3 ± 0.2 |

### Example A—Cation Exchange

The mixed niobium oxide has been modified through a cation substitution approach in samples 3-9, focused at the Nb⁵⁺ cations within the 3×4 block of NbO₆ octahedra. In the case of samples 3-6, the exchange has been carried out with a cation of reduced valency. Samples 7-8 show increased valency, and sample 9 shows isovalent exchange. This is expected to provide an advantage versus the base crystal structure of sample 1 through the combination of (a) altered ionic radii, (b) altered valency, and (c) altered voltage. Altered ionic radii can give rise to beneficial changes in electrochemical performance due to changing unit cell size and local distortions in crystal structure altering available lithiation sites or lithiation pathways—potentially improving Coulombic efficiency, capacity, performance at high rate, and lifetime. For example, the ionic radius of the 6-coordinate Nb⁵⁺ cation is 0.64 Å vs the ionic radius of 6-coordinate Al³⁺ cation of 0.54 Å in sample 5. Cation exchange provides significantly improved electrical conductivity of the material compared to the unmodified sample 1*, believed to be due to providing available intermediate energy levels for charge carriers, as shown in Table 3. Moreover, the cation exchange samples in Table 4 show an advantage in specific capacity and Coulombic efficiency compared to the unmodified sample 1*. If the substitution takes place in the same cation site, then the O-content of the material will be decreased proportionally to maintain a charge-balanced structure (i.e. oxygen deficient vs the base MoNb₁₂O₃₃ structure).

Table 2 demonstrates the alterations in unit cell parameters observed upon cation exchange, observed due to alterations of ionic radii and electronic structure of these materials.

It is expected that similar benefits will be observed with the described cation exchange approach for this material for use in Li-ion cells.

### Example B—Anion Exchange

The mixed niobium oxide has been modified through the introduction of N³⁻ anions (cf. nitridation) to provide Sample 10. This was carried out by a solid-state synthesis route but could equally be carried out with a gaseous route utilising NH₃ gas at high temperature, or through use of a dissolved N-containing material in a solvent that is subsequently evaporated followed by high temperature heat treatment. Sample 10 is grey/blue compared to Sample 2**, which is off-white, demonstrating changes to the active material electronic structure in a similar fashion to Example A.

In a similar fashion to Example A with cation exchange, this exchange may take place in an O²⁻ anion site, in which case the increased valency may increase the electronic conductivity of the material. It may also take place in an interstitial site within the crystal structure. In both cases, this may also give rise to different unit cell size and associated crystallographic distortions due to the differing ionic radii and valency of the anions, providing similar potential benefits to Example A.

In a similar fashion, the mixed niobium oxide can be altered through the introduction of F⁻ anions to provide samples 12 and 13, providing an advantage in the Coulombic efficiency versus the reference samples 1 and 2.

Table 2 demonstrates the change in unit cell parameters that take place upon introduction of N³⁻ anions or F⁻ anions, providing further evidence for anion incorporation within the crystal structure.

FIG. 2 further shows evidence of N or F incorporation by the change in the characteristic peaks corresponding to Nb—O bonds at 500-700 cm⁻¹ in the Raman spectra.

It is expected that similar benefits will be observed through the use of anions of different electronegativity and valency with any of the described MNO structures for use in Li ion cells.

### Example C—Induced Oxygen Vacancy Defects

Sample 5, 7, and 10 have been modified through the introduction of induced oxygen vacancy defects (cf. oxygen deficiency) by a heat treatment in an inert or reducing atmosphere to provide Samples 14, 15, and 17. By treating these materials at high temperature in an inert or reducing atmosphere, they may be partially reduced and maintain this upon return to room temperature and exposure to an air atmosphere. This is accompanied with an obvious colour change, for example Sample 15 is purple/blue in colour vs white for Sample 7. This colour change demonstrates a significant change in the electronic structure of the material, allowing it to interact with different energies (i.e. wavelength) of visible light due to the reduced band gap.

The induced oxygen vacancy is specifically a defect in the crystal structure where an oxygen anion has been removed, and the overall redox state of the cations is reduced in turn. This provides additional energetic states improving material electrical conductivity significantly, and alters the band gap energy as demonstrated by colour changes. If induced oxygen vacancies are present beyond 5 atomic % (i.e. c>1.65), then the crystal structure collapses due to a loss in stability resulting in a mixture of reduction by products. These induced oxygen vacancies can be present in addition to oxygen deficiency caused by the use of subvalent cation exchange, as shown in Sample 14.

Evidence of oxygen deficiency is provided here by Raman spectra in FIG. 2, as in Example B. A host of other techniques can also be employed as described above to quantify oxygen deficiency.

It is expected that similar benefits will be observed with the described approach to induce oxygen vacancy defects for this material for use in Li-ion cells.

### Discussion

Comparative Sample 1* or 2** may also be modified with more than one type of cation/anion substitution, or induced oxygen deficiency (i.e. a>0 and b>0; or a>0, d>0; or a>0, b>0, c>0, and so on). Samples 3-9 demonstrates the effect of having a>0 and b>0; Sample 16 demonstrates the effect of having a>0, b>0, c>0 and d>0. Improvements as described for Examples A-C are expected for these materials that demonstrate multiple types of modifications.

Table 2 demonstrates changes in unit cell parameters for modified materials reflecting the alterations to the materials that have taken place at the crystal level. All samples show improvements in the electrical resistance vs Sample 1* as shown in Table 3. Electrochemical measurements additionally show significant advantages for modified samples vs Sample 1* in 2^{nd} cycle Coulombic efficiencies as in Table 4. Moreover, modifying Sample 2** by including substitution at the Nb site and/or at the O site provided improved 2^{nd} cycle delithiation specific capacity, an important result demonstrating the utility of the modified materials for use as active electrode materials.

Modifying the ‘base’ material by introducing increased degrees of disorder in the crystal structure (cf. entropy) can aid in reversible lithiation processes by providing less significant energy barriers to reversible lithiation, and preventing Li ion ordering within a partially lithiated crystal. This can also be defined as creating a spread in the energetic states for Li ion intercalation, which prevents unfavourable lithium ordering and entropic energy barriers. This can be inferred from examining dQ/dV or Cyclic Voltammetry plots.

It is expected that similar benefits will be observed in any of the described MNO structures utilising any combination of M1, M2, M3, Q, a, b, c, and d within the described limits for use in Li ion cells.

Mixtures with LTO

A modified mixed niobium oxide was tested as an active electrode material in combination with a commercial material, demonstrating the utility of the modified mixed niobium oxides for incorporation into and improvement of existing battery technologies.

Commercial-grade LTO (Li₄Ti₅O₁₂) was purchased from Targray Technology International Inc with properties outlined in Table E1 (Sample E1). The Wadsley-Roth material was synthesised in-house by a solid-state route. In a first step precursor materials (e.g. Nb₂O₅, WO₃, MoO₃, and ZnO) were mixed in stoichiometric proportions (200 g total) and ball-milled at 550 rpm with a ball to powder ratio of 10:1 for 3 h. The resulting powder was heat treated in an alumina crucible in a muffle furnace in air at T₁=900° C. for 12 h, providing the desired Wadsley-Roth phase.

Active electrode material mixtures of MNO and LTO were obtained by low to high energy powder mixing/blending techniques, such as by rotational mixing in multiple directions, rotational V-type blending over a single axis, planetary mixing, centrifugal planetary mixing, high shear mixing, and other typical mixing/blending techniques. In this case, mixing was achieved with a centrifugal planetary mixer on 5 g batches of materials, mixed at 2000 rpm for 3 mins, 10 times.

TABLE E3
A summary of the materials utilised. Particle size distribution
has been evaluated by dry powder laser diffraction.

| | | | | | BET Surface |
|---|---|---|---|---|---|
| Sample | Material | D10 (μm) | D50 (μm) | D90 (μm) | Area [m² g⁻¹] |
| E1 | LTO (from commercial supplier) | 0.8 | 2.5 | 5.0 | 16.0* |
| E2 | Mo_{0.75}W_{0.25}Zn_{0.05}Nb_{11.95}O_{32.975} | 1.6 | 4.5 | 9.0 | — |

*From manufacturer specification sheet.

### Material Characterisation

The phase purity of samples was analysed using a Rigaku Miniflex powder X-ray diffractometer in 20 range (20-70°) at 1°/min scan rate. The diffraction pattern for Sample E1 matches JCPDS crystallography database entry JCPDS 49-0207, which corresponds to the spinal crystal structure of Li₄Ti₅O₁₂. There is no amorphous background noise and the peaks are sharp and intense. This means that the sample is crystalline, with crystallite size 43±7 nm according to the Scherrer equation. The diffraction pattern for Sample E2 matches JCPDS crystallography database entry JCPDS 73-1322, which corresponds to MoNb₁₂O₃₃. This confirms the presence of a Wadsley-Roth crystal structure.

Particle Size Distributions were obtained with a Horiba laser diffraction particle analyser for dry powder. Air pressure was kept at 0.3 MPa. The results are set out in Table E1. BET surface area analysis was carried out with N₂ on a BELSORP-miniX instrument at 77.35 K and are set out in Table E1.

### Electrochemical Characterisation

Electrochemical tests were carried out in half-coin cells (CR2032 size) for analysis. There are some differences to the testing methodology used for Samples 1-17 above, meaning that the results may not be directly comparable. In half-coin tests, the active material is tested in an electrode versus a Li metal electrode to assess its fundamental performance. In the below examples, the active material composition to be tested was combined with N-Methyl Pyrrolidone (NMP), carbon black acting as a conductive additive, and poly(vinyldifluoride) (PVDF) binder and mixed to form a slurry using a lab-scale centrifugal planetary mixer. The non-NMP composition of the slurries was 90 wt % active material, 6 wt % conductive additive, 4 wt % binder. The slurry was coated on an Al foil current collector to the desired loading of 5.7-6.5 mg cm⁻² by doctor blade coating and dried. The electrodes were then calendared to a density of 2.00-3.75 g cm⁻³ (dependent on material density) at 80° C. to achieve targeted porosity of 35-40%. Porosity was calculated as the measured electrode density divided by the weighted average density of each component of the composite electrode coating film. Electrodes were punched out at the desired size and combined with a separator (Celgard porous PP/PE), Li metal, and electrolyte (1.3 M LiPF₆ in EC/DEC) inside a steel coin cell casing and sealed under pressure. Cycling was then carried out at low current rates (C/10) for 2 full cycles of lithiation and de-lithiation between 1.1-3.0 V. Afterwards, the cells were tested for their performance at increasing current densities. During rate tests, the cells were cycled asymmetric, with a slow lithiation (C/5, with a CV step at 1.1 V to C/20 current density) followed by increasing de-lithiation rates for de-lithiation rate tests. All electrochemical tests were carried out in a thermally controlled environment at 23° C.

To quantify the significance of the differences in data observed, an error calculation was carried out and applied to the values for specific capacity. The error for these was approximated as the largest error possible with the microbalance used (±0.1 mg), and the lowest loading electrode (5.7 mg cm⁻²) on a 14 mm electrode disc. This provides an error of ±1.1%, which has been applied to each capacity measurement. Error in Coulombic efficiency, capacity retention, and voltage were assumed to be negligible as the instrument accuracy far exceeds the stated significant figures, and the values are independent of the balance errors.

TABLE E2
A summary of the electrochemical tests undertaken with Samples E1
and E2. Achieved electrode conditions are also referenced for each
test, providing smooth electrodes free of agglomerates, that demonstrate
good adhesion and cohesion to the current collector.

| Test Ref. | A* | B | C |
|---|---|---|---|
| Content of Sample E1 [w/w %] | 100 | — | 50 |
| Content of Sample E2 [w/w %] | — | 100 | 50 |
| Electrode loading [mg cm⁻²] | 6.3 | 6.3 | 6.4 |

TABLE E3
A summary of electrochemical testing
results from Li-ion half coin cells.

| | De-lithiation specific | Initial coulombic |
|---|---|---|
| Test | capacity C/10 [mAh/g] | efficiency [%] |
| A* | 161 ± 2 | 96.86 |
| B | 194 ± 2 | 88.42 |
| C | 175 ± 2 | 90.96 |

TABLE E4
A summary of electrochemical testing results at increasing
current densities from Li-ion half coin cells.

| | 1 C/0.5 C | 2 C/0.5 C | 5 C/0.5 C | 10 C/0.5 C |
|---|---|---|---|---|
| | de-lithiation | de-lithiation | de-lithiation | de-lithiation |
| | capacity | capacity | capacity | capacity |
| Test | retention [%] | retention [%] | retention [%] | retention [%] |
| A* | 99.4 | 98.8 | 97.5 | 96.3 |
| B | 97.3 | 95.7 | 94.1 | 88.8 |
| C | 98.9 | 98.3 | 96.0 | 89.1 |

TABLE E5
A summary of the nominal de-lithiation voltage at each C-rate.

| | Nominal De-lithiation Voltage vs Li/Li⁺ [V] | | | | |
|---|---|---|---|---|---|
| Test | 0.1 C | 0.5 C | 2 C | 5 C | 10 C |
| A* | 1.57 | 1.59 | 1.61 | 1.67 | 1.78 |
| B | 1.71 | 1.71 | 1.82 | 2.00 | 2.27 |
| C | 1.65 | 1.67 | 1.77 | 1.97 | 2.25 |

### REFERENCE EXAMPLES

The following reference examples demonstrate the improvement in properties of modified MoNb₁₂O₃₃ and WNb₁₂O₃₃ compared to the unmodified ‘base’ mixed niobium oxides. The reference examples are modified by partial substitution of M2 (Mo or W) for M1 and/or by inducing oxygen deficiency. It would be expected that the same improvements would be seen when the oxides are further modified by partial substitution of Nb for M3 and/or partial substitution of O for Q in accordance with the invention.

A number of different materials were prepared and characterised, as summarised in Table 5, below. Broadly, these samples can be split into a number of groups. Samples R1, R2, R3, R4, R5, R8, R9, R10, R11, and R12 belong to the same family of Wadsley-Roth phases based on MoNb₁₂O₃₃ (M⁶⁺Nb₁₂O₃₃, 3×4 block of octahedra with a tetrahedron at each block corner). The blocks link to each other by edge sharing between NbO₆ octahedra, as well as corner sharing between M⁶⁺O₄ tetrahedra and NbO₆ octahedra. Sample R1 is the base crystal structure, which is modified to a mixed metal cation structure by exchanging one or multiple cations in samples R2 to R4, and/or in a mixed crystal configuration (blending with isostructural WNb₁₂O₃₃) in samples R8, R9, R10, R11, and R12. Oxygen deficiencies are created in the base crystal in sample R5 and in the mixed metal cation structure R11. Sample R3 is a spray-dried and carbon-coated version of the crystal made in sample R2, and sample R12 is a spray-dried and carbon-coated version of the crystal made in sample R10. Samples R6, R7 and R13 belong to the same family of Wadsley-Roth phases based on WNb₁₂O₃₃ (M⁶⁺Nb₁₂O₃₃, a 3×4 NbO₆ octahedra block with a tetrahedron at each block corner).

TABLE 5
A summary of different compositions synthesised.
Samples indicated with * are comparative samples.

| Sample No. | Composition | Material Synthesis |
|---|---|---|
| R1* | MoNb₁₂O₃₃ | Solid state |
| R2 | Ti_{0.05}Mo_{0.95}Nb₁₂O_{32.95} | Solid state |
| R3 | Ti_{0.05}Mo_{0.95}Nb₁₂O_{32.95} + C | Solid state, |
| | | spray dry, |
| | | carbon pyrolysis |
| R4 | Zr_{0.05}Mo_{0.95}Nb₁₂O_{32.95} | Solid state |
| R5 | MoNb₁₂O_{<33} | Solid state |
| R6* | WNb₁₂O₃₃ | Solid state |
| R7 | Ti_{0.05}W_{0.95}Nb₁₂O_{32.95} | Solid state |
| R8 | W_{0.25}Mo_{0.75}Nb₁₂O₃₃ | Solid state |
| R9 | Ti_{0.05}W_{0.25}Mo_{0.70}Nb₁₂O_{32.95} | Solid state |
| R10 | Ti_{0.05}Zr_{0.05}W_{0.25}Mo_{0.65}Nb₁₂O_{32.9} | Solid state |
| R11 | Ti_{0.05}Zr_{0.05}W_{0.25}Mo_{0.65}Nb₁₂O_{<32.9} | Solid state |
| R12 | Ti_{0.05}Zr_{0.05}W_{0.25}Mo_{0.65}Nb₁₂O_{32.9} + C | Solid state, |
| | | spray dry, |
| | | carbon pyrolysis |
| R13 | WNb₁₂O_{33-α} | Solid state |

### Material Synthesis

Samples listed in Table 5 were synthesised using a solid-state route. In a first step, metal oxide precursor commercial powders (Nb₂O₅, NbO₂, MoO₃, ZrO₂, TiO₂, WO₃, V₂O₅, ZrO₂, K₂O, CoO, ZnO and/or MgO) were mixed in stoichiometric proportions and planetary ball-milled at 550 rpm for 3 h in a zirconia jar and milling media with a ball to powder ratio of 10:1. The resulting powders were then heated in a static muffle furnace in air in order to form the desired crystal phase. Samples R1 to R5 and R8 to R12 were heat-treated at 900° C. for 12 h; samples R6 to R7 were heat-treated at 1200° C. for 12 h. Sample R3 and R12 were further mixed with a carbohydrate precursor (such as sucrose, maltodextrin or other water-soluble carbohydrates), dispersed in an aqueous slurry at concentrations of 5, 10, 15, or 20 w/w % with ionic surfactant, and spray-dried in a lab-scale spray-drier (inlet temperature 220° C., outlet temperature 95° C., 500 mL/h sample introduction rate). The resulting powder was pyrolyzed at 600° C. for 5 h in nitrogen. Sample R5 and R11 were further annealed in nitrogen at 900° C. for 4 hours.

Sample R13 was prepared by ball milling as above, and impact milling at 20,000 rpm as needed to a particle size distribution with D90<20 μm, heat-treated as in a muffle furnace in air at 1200° C. for 12 h and then further annealed in nitrogen at 1000° C. for 4 h.

### XRD Characterisation of Samples

The phase purity of some samples was analysed using Rigaku Miniflex powder X-ray diffractometer in 20 range (10-70°) at 1°/min scan rate.

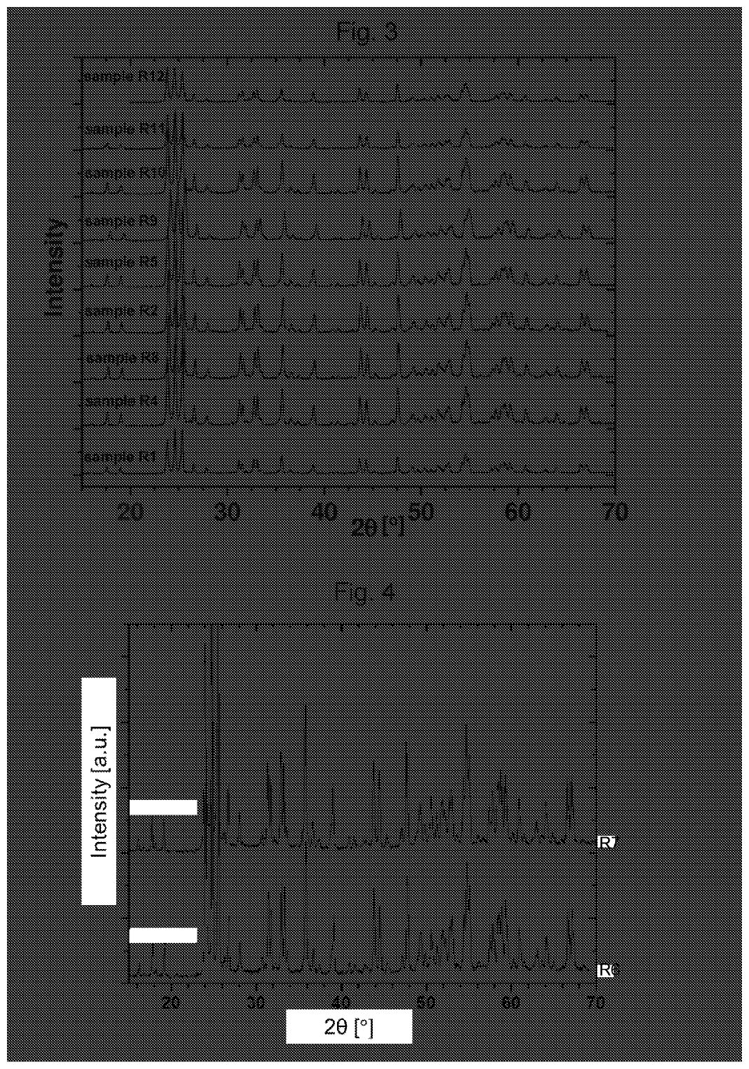

FIG. 3 shows the measured XRD diffraction patterns for samples R1, R4, R8, R2, R5, R9, R10, R11, R12 which are relevant to Comparative Study A. All diffraction patterns have peaks at the same locations (within instrument error, that is 0.1°), and match JCPDS crystallography database entry JCPDS 73-1322. There is no amorphous background noise and the peaks are sharp and intense. This means that all samples are phase-pure and crystalline, with crystallite size˜200 nm according to the Scherrer equation and crystal structure matching MoNb₁₂O₃₃.

FIG. 4 shows the measured XRD diffraction patterns for samples R6 and R7. All diffraction patterns have peaks at the same locations (within instrument error, that is 0.1°), and match JCPDS crystallography database entry JCPDS 73-1322. There is no amorphous background noise and the peaks are sharp and intense. This means that all samples are phase-pure and crystalline, with crystallite size˜200 nm according to the Scherrer equation and crystal structure matching WNb₁₂O₃₃.

### Qualitative Assessment of Oxygen Deficiency

As discussed above, sample R5 and R11 were heat-treated at 900° C. for 12 h to form the active electrode material, and was then further annealed in nitrogen (a reducing atmosphere) at 900° C., in a post-processing heat treatment step. A colour change from white to dark purple was observed after the post-processing heat treatment in nitrogen, indicating change in oxidation states and band structure of the material, as a result of oxygen deficiency of the sample.

Sample R13 was further annealed in nitrogen at 1000° C. for 4 h. Sample R6 transitions from off-white to light blue in R13.

### Electrochemical Testing of Samples

Electrochemical tests were carried out in half-coin cells (CR2032 size) for initial analysis. In half-coin tests, the material is tested in an electrode versus a Li metal electrode to assess its fundamental performance. In the below examples, the active material composition to be tested was combined with N-Methyl Pyrrolidone (NMP), carbon black acting as a conductive additive, and poly(vinyldifluoride) (PVDF) binder and mixed to form a slurry using a lab-scale centrifugal planetary mixer (although it is also possible to form aqueous slurries by using water rather than NMP). The non-NMP composition of the slurries was 80 w.% active material, 10 w.% conductive additive, 10 w.% binder. The slurry was then coated on an Al foil current collector to the desired loading of 1 mg/cm² by doctor blade coating and dried in a vacuum oven for 12 hours. Electrodes were punched out at the desired size and combined with a separator (Celgard porous PP/PE), Li metal, and electrolyte (1 M LiPF₆ in EC/DEC) inside a steel coin cell casing and sealed under pressure. Formation cycling was then carried out at low current rates (C/20) for 2 full charge and discharge cycles. After formation, further cycling can be carried out at a fixed or varied current density as required. These tests have been termed “half-cell galvanostatic cycling” for future reference. Homogeneous, smooth coatings on current collector foil, the coatings being free of visible defects were also prepared as above with a centrifugal planetary mixer to a composition of 94 w.% active material, 4 w.% conductive additive, 2 w.% binder. The coatings were calendared at 80° C. to a density of up to 3.0 g/cm³ at loadings of 1.3-1.7 mAh/cm² in order to demonstrate possible volumetric capacities>700 mAh/cm³ in the voltage range 0.7-3.0 V at C/20, and >640 mAh/cm³ in the voltage range 1.1-3.0 V at C/5. This is an important demonstration of these materials being viable in a commercially focused electrode power cell formulation, where retaining performance after calendaring to a high electrode density allows for high volumetric capacities. Loadings of up to and including 1.0, 1.5, 2.0, 2.5, or 3.0 mAh/cm² may be useful for Li-ion cells focused on power performance; loadings greater than 3.0, 4.0, or 5.0 mAh/cm² are useful for energy-focused performance in Li ion cells. Calendaring of these materials was demonstrated down to electrode porosity values of 35%, and typically in the range 35-40%; defined as measured electrode density divided by the average of the true densities of each electrode component adjusted to their w/w %. Some of the data obtained for the Reference Examples may not have been obtained under identical conditions to the data obtained for the Examples. Therefore, the absolute values obtained for the Reference Examples and the Examples may not be directly comparable.

Electrical conductivity of electrodes made with the samples listed in Table 5 was measured using a 4-point probe thin film resistance measurement apparatus. Slurries were formulated according to the procedure described above and coated on a dielectric mylar film at a loading of 1 mg/cm². Electrode-sized discs where then punched out and resistance of the coated-film was measured using a 4-point probe. Bulk resistivity can be calculated from measured resistance using the following equation:

$$Bulk resistivity ( ρ ) = 2 π s ( V / I ) ; R = V / I ; s = 0.1 cm = 2 π \times 0.1 \times R ( Ω ) \qquad ( 3 )$$

The results of this test are shown in Table 6:

TABLE 6
Summary of 4-point probe resistivity measurement
results for samples R1, R2, R4, R5 and R8 to R12.

| Sample | Resistance [kΩ] | Bulk resistivity [kΩ · cm] |
|---|---|---|
| R1* | 8.5 | 5.3 |
| R2 | 1.7 | 1.1 |
| R4 | 3.2 | 2.0 |
| R5 | 0.52 | 0.33 |
| R8 | 2.7 | 1.7 |
| R9 | 1.2 | 0.75 |
| R10 | 1.3 | 0.82 |
| R11 | 0.89 | 0.56 |
| R12 | 0.33 | 0.21 |

The results of this test are shown in Table 7:

TABLE 7
Summary of DCIR/ASI measurement results
for samples R1, R2, R4, R8, R10-R12.

| Sample | ASI / Ω · cm² |
|---|---|
| R1* | 141 |
| R2 | 125 |
| R4 | 120 |
| R8 | 99 |
| R10 | 74 |
| R11 | 75 |
| R12 | 121 |

The reversible specific capacity C/20, initial coulombic efficiency, nominal lithiation voltage vs Li/Li⁺ at C/20, 5 C/0.5 C capacity retention, and 10 C/0.5 C capacity retention for a number of samples were also tested, the results being set out in Table 8, below. Nominal lithiation voltage vs Li/Li+ has been calculated from the integral of the V/Q curve divided by the total capacity on the 2^{nd} cycle C/20 lithiation. Capacity retention at 10 C and 5 C has been calculated by taking the specific capacity at 10 C or 5 C, and dividing it by the specific capacity at 0.5 C. It should be noted that the capacity retention was tested with symmetric cycling tests, with equivalent C-rate on lithiation and de-lithiation. Upon testing with an asymmetric cycling program, 10 C/0.5 C capacity retention greater than 89% is routinely observed.

TABLE 8
Summary of electrochemical testing results from Li-ion half coin
cells using a number of samples. In general (although not exclusively)
it is beneficial to have a higher capacity, a higher ICE, a lower
nominal voltage, and higher capacity retentions.

| | Reversible | | Nominal | | |
|---|---|---|---|---|---|
| | specific | Initial | lithiation | 5 C/0.5 C | 10 C/0.5 C |
| | capacity | coulombic | voltage vs | capacity | capacity |
| | C/20 | efficiency | Li/Li⁺ | retention | retention |
| Sample | [mAh/g] | [%] | [V] | [%] | [%] |
| R1* | 214 | 87.8 | 1.61 | 62 | 35 |
| R2 | 240 | 90.9 | 1.61 | 64 | 45 |
| R3 | 203 | 84.9 | 1.58 | 79 | 68 |
| R4 | 286 | 90.7 | 1.59 | 68 | 54 |
| R5 | 253 | 86.0 | 1.60 | 63 | 43 |
| R6* | 192 | 82.0 | 1.60 | 54 | 36 |
| R7 | 188 | 86.8 | 1.61 | 64 | 54 |
| R8 | 278 | 91.0 | 1.59 | | |
| R9 | 228 | 89.2 | 1.59 | | |
| R10 | 281 | 90.8 | 1.58 | 72 | 58 |
| R11 | 228 | 90.1 | 1.59 | 84 | 68 |
| R12 | 267 | 86.9 | 1.57 | 71 | 62 |

The modification of MoNb₁₂O₃₃ and WNb₁₂O₃₃ as shown above demonstrates the applicability of cation substitution improve active material performance in Li-ion cells. By substituting the non-Nb cation to form a mixed cation structure as described, the entropy (cf disorder) can increase in the crystal structure, reducing potential energy barriers to Li ion diffusion through minor defect introduction (e.g. R10). Modification by creating mixed cation structures that retain the same overall oxidation state demonstrate the potential improvements by altering ionic radii, for example replacement of an Mo⁶⁺ cation with W⁶⁺ in sample R8, which can cause minor changes in crystal parameters and Li-ion cavities (e.g. tuning the reversibility of Type VI cavities in Wadsley-Roth structures) that can improve specific capacity, Li-ion diffusion, and increase Coulombic efficiencies of cycling by reducing Li ion trapping. Modification by creating mixed cation structures that result in increased oxidation state is expected to demonstrate similar potential advantages with altered ionic radii relating to capacity and efficiency, compounded by introduction of additional electron holes in the structure to aid in electrical conductivity. Modification by creating mixed cation structures that result in decreased oxidation state (e.g. Ti⁴⁺ to replace Mo⁶⁺ in sample R2) demonstrate similar potential advantages with altered ionic radii relating to capacity and efficiency, compounded by introduction of oxygen vacancies and additional electrons in the structure to aid in electrical conductivity. Modification by inducing oxygen deficiency from high temperature treatment in inert or reducing conditions demonstrate the loss of a small proportion of oxygen from the structure, providing a reduced structure of much improved electrical conductivity (e.g. sample R5) and improved electrochemical properties such as capacity retention at high C-rates (e.g. sample R5). Combination of mixed cation structures and induced oxygen deficiency allows multiple beneficial effects (e.g. increased specific capacity, reduced electrical resistance) to be compounded (e.g. sample R11).

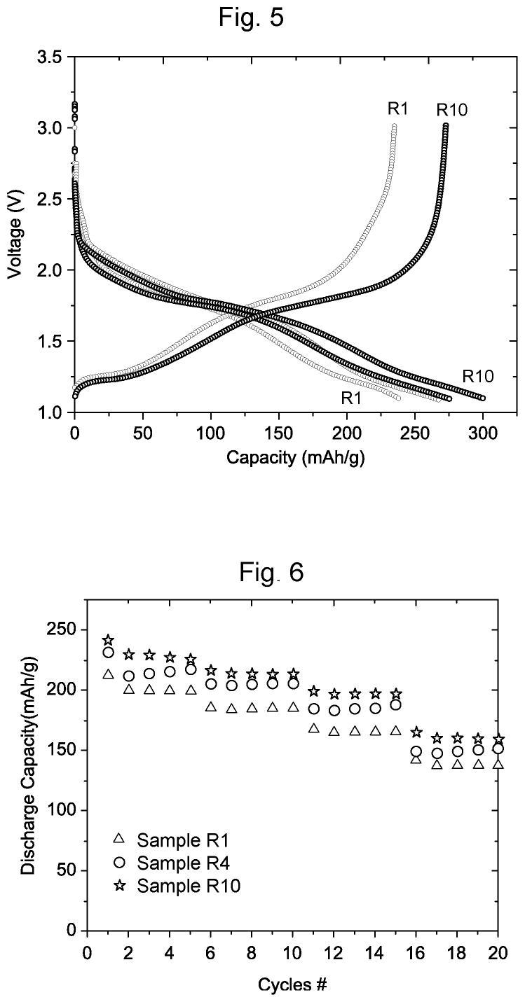

FIG. 5 shows representative lithiation/delithiation curves for unmodified and modified MoNb₁₂O₃₃ (samples R1 and R10), in their first two formation cycles at C/20 rate. In FIG. 5, approximately 90% of the specific capacity for sample R10 demonstrated is shown to be in a narrow voltage range of ca. 1.2-2.0 V; these data highlight the attractive voltage profiles achievable with MNO crystals based upon Wadsley-Roth crystal structures. Secondly, the complex metal oxide sample R10 demonstrates improved specific capacity as compared to its unmodified crystals sample R1. This is due to the cations that are included in the complex structures increasing the number of sites in the crystal that Li ions can accommodate due to their differing ionic radii and oxidation states, thus increasing capacity. An increase in ICE was observed between samples R1 and R10 which further demonstrates that Li ions intercalated in the modified crystal structure can be more efficiently delithiated as the Li ion sites are modified to enable their de-intercalation.

Across all materials tested, each modified material demonstrates an improvement versus the unmodified ‘base’ crystal structure. This is inferred from measurements of resistivity/impedance by two different methods, and also electrochemical tests carried out in Li-ion half coin cells, particularly the capacity retention at increased current densities (cf. rates, Table 8, FIG. 6). Without wishing to be bound by theory, the inventors suggest that this is a result of increased ionic and electronic conductivity of the materials as defects are introduced, or by alterations to the crystal lattice by varying ionic radii; also evidenced by DCIR/ASI (Table 7) measurements to show decreased resistance or impedance upon material modification. Li-ion diffusion rates likely also increase in modified materials as compared with the unmodified ‘base’ materials. Specific capacities themselves may also increase in some cases as shown in Table 8, as doping/exchange with metal ions of different sizes can expand or contract the crystal lattice and allow for more intercalation or more reversibility of intercalation of Li-ions than possible in the unmodified structure.

The data in Table 6 show a large reduction in the resistivity between sample R1 (comparative) and samples R2, R4, R5, R8, R9, R10, R11, R12, demonstrating the effect of the modification on improving electrical conductivity of the crystal structures through both cation exchange, oxygen deficiencies, and carbon coating.

The data in Table 7 shows a large reduction in the DCIR/ASI from sample R1 (comparative) to samples R2, R4, R8, R10, R11 and R12, reflecting the trends shown in Table 6.

In Table 8, across most samples there is a trend for improved specific capacities, initial Coulombic efficiencies (ICE), nominal lithiation voltage vs Li/Li⁺, and capacity retention at 5 C and 10 C vs 0.5 C for modified materials versus the comparative ‘base’ materials (e.g. samples R1, R8). For example samples R2, R3, R4, R5, R8, R9, R10, R11, R12 all demonstrate improvements in one or more of these parameters vs sample R1. This is also the case for sample R7 versus R6 where ICE and capacity retention are improved.

FIG. 6 demonstrate improved capacity retention at higher cycling rates for modified materials (samples R4, R10) versus the comparative material (sample R1).

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention. For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

1. An active electrode material comprising a mixed niobium oxide, wherein the mixed niobium oxide has the composition M1ₐM2₁₋ₐM3_{b}Nb_{12-b}O_{33-c-d}Q_{d}, wherein:
M1 and M2 are different;
M1 is selected from Mg, Ti, Zr, V, Nb, Ta, Cr, Mo, W, Mn, Fe, Co, Ni, Cu, Zn, Cd, B, Al, Si, P, and mixtures thereof;
M2 is Mo or W;
M3 is selected from Mg, Ti, Zr, V, Ta, Cr, Mo, W, Mn, Fe, Co, Ni, Cu, Zn, Cd, B, Al, Si, P, and mixtures thereof;
Q is selected from F, N, and mixtures thereof;
0≤a<0.5; 0≤b≤2; −0.5≤c≤1.65; 0≤d≤1.65;
one or more of b and d is >0.

2. The active electrode material of claim 1, wherein
(i) a>0; and/or
(ii) 0≤a≤0.45; and/or
(iii) 0≤a≤0.3.

3. The active electrode material of claim 1, wherein
(i) b>0; and/or
(ii) 0≤b≤1.0; and/or
(iii) 0≤b≤0.2.

4. The active electrode material of claim 1, wherein
(i) c≠0; or
(ii) 0≤c≤1.65; or
(iii) 0<c≤1.65.

5. The active electrode material of claim 1, wherein
(i) d>0; and/or
(ii) 0≤d≤1.0; and/or
(iii) 0≤d≤0.8; or
(iv) d=0.

6. The active electrode material of claim 1, wherein both b and d are >0.

7. The active electrode material of claim 1, wherein M1 is selected from
Ti, Zr, V, Cr, Mo, W, Fe, Cu, Zn, Al, P, and mixtures thereof.

8. The active electrode material of claim 1, wherein M2 is Mo.

9. The active electrode material of claim 1, wherein M3 is selected from
Ti, Zr, V, Cr, Mo, W, Fe, Cu, Zn, Al, P, and mixtures thereof.

10. The active electrode material of claim 1, wherein
(i) M1 has a 4-coordinate ionic radius 0.1<r<1.0 Å; and/or
(ii) M1 has a different 4-coordinate ionic radius than 4-coordinate M2⁶⁺; and/or
(iii) M1 has a 4-coordinate ionic radius 0.35<r<0.48 Å.

11. The active electrode material of claim 1, wherein
(i) M3 has a 6-coordinate ionic radius 0.1<r<1.0 Å; and/or
(ii) M3 has a different 6-coordinate ionic radius than 6-coordinate Nb⁵⁺; and/or
(iii) M3 has a 6-coordinate ionic radius 0.54<r<0.74 Å.

12. The active electrode material of claim 1, wherein
(i) M1 has a lower valency than 6+; or
(ii) M3 has a lower valency than 5+; or
(iii) M1 has a lower valency than 6+ and M3 has a lower valency than 5+.

13. The active electrode material of claim 1, wherein M1 does not comprise Nb and wherein M3 does not comprise Mo or W.

14. The active electrode material of claim 1, wherein
Q is N.

15. The active electrode material according to claim 1, wherein the mixed niobium oxide has the composition M1ₐM2₁₋ₐM3_{b}Nb_{12-b}O_{33-c-d}Q_{d}, wherein:
M1 and M2 are different;
M1 is selected from Ti, Zr, V, Cr, Mo, W, Fe, Cu, Zn, Al, P, and mixtures thereof;
M2 is Mo or W;
M3 is selected from Ti, Zr, V, Cr, Mo, W, Fe, Cu, Zn, Al, P, and mixtures thereof;
Q is selected from F, N, and mixtures thereof;
one or more of b and d is >0.

16. The active electrode material according to claim 1, wherein the mixed niobium oxide is oxygen deficient.

17. The active electrode material according to claim 1, wherein the mixed niobium oxide is coated with carbon.

18. The active electrode material according to claim 17, wherein the carbon coating comprises polyaromatic sp² carbon.

19. The active electrode material according to claim 1, wherein the mixed niobium oxide is in particulate form, wherein the mixed niobium oxide has a D₅₀ particle diameter in the range of 0.1-100 μm, or 0.5-50 μm, or 1-20 μm.

20. The active electrode material according to claim 1, wherein the mixed niobium oxide has a BET surface area in the range of 0.1-100 m²/g, or 0.5-50 m²/g, or 1-20 m²/g.

21. The active electrode material according to claim 1, wherein the mixed niobium oxide further comprises Li and/or Na.

22. The active electrode material according to claim 1, wherein the crystal structure of the mixed niobium oxide as determined by X-ray diffraction corresponds to the crystal structure of MoNb₁₂O₃₃ or WNb₁₂O₃₃.

23-24. (canceled)

25. An electrode comprising the active electrode material of claim 1 in electrical contact with a current collector.

26. An electrochemical device comprising an anode, a cathode, and an electrolyte disposed between the anode and the cathode, wherein the anode comprises an active electrode material according to claim 1.

27. An electrochemical device according to claim 26, wherein the electrochemical device is a lithium-ion battery having a reversible anode active material specific capacity of greater than 200 mAh/g at 20 mA/g, wherein the battery can be charged and discharged at current densities relative to the anode active material of 200 mA/g or more, or 1000 mA/g or more, or 2000 mA/g or more, or 4000 mA/g or more whilst retaining greater than 70% of the initial cell capacity at 20 mA/g.

28. A method of making a mixed niobium oxide as defined by claim 1, the method comprising steps of:
providing one or more precursor materials;
mixing said precursor materials to form a precursor material mixture; and
heat treating the precursor material mixture in a temperature range from 400° C.-1350° C. or 800° C.-1250° C., thereby providing the mixed niobium oxide.

29-31. (canceled)
